(19) United States
(12) Patent Application Publication
(10) Pub. No.: US 2024/0250770 A1
(43) Pub. Date: Jul. 25, 2024

(54) OPTICAL TRANSMISSION APPARATUS, SYSTEM, METHOD, AND NON-TRANSITORY COMPUTER READABLE MEDIUM

(71) Applicant: NEC Corporation, Minato-ku, Tokyo (JP)

(72) Inventor: Masaki Sato, Tokyo (JP)

(73) Assignee: NEC Corporation, Minato-ku, Tokyo (JP)

(21) Appl. No.: 18/562,554

(22) PCT Filed: May 28, 2021
(86) PCT No.: PCT/JP2021/020455

§ 371 Date: Nov. 20, 2023

(51) Int. Cl. H04J 14/02; H04B 10/556

(52) U.S. Cl. CPC H04J 14/0298; H04B 10/5561

(57) ABSTRACT

An object of the present disclosure is to provide an optical transmission apparatus, system, method, and non-transitory computer readable medium that can reduce noise generated due to IQ mixing in a subcarrier multiplexing method. An optical transmission apparatus according to the present disclosure includes pilot addition means for generating a first digital signal by adding a first pilot signal to a first data signal and generating a second digital signal by adding a second pilot signal to a second data signal, and optical modulation means for generating an optical modulation signal by optically modulating the first digital signal with a first subcarrier (SC1) included in a negative frequency band to a center frequency of a used frequency band, optically modulating the second digital signal with a second subcarrier (SC2) included in a positive frequency band to the center frequency of the used frequency band, and transmitting the optical modulation signal.

### TECHNICAL FIELD

The present disclosure relates to an optical transmission apparatus, system, method, and non-transitory computer readable medium. In particular, the present disclosure relates to an optical transmission apparatus, system, method, and non-transitory computer readable medium capable of reducing noise generated by IQ mixing in a subcarrier multiplexing method.

### BACKGROUND ART

A digital Sub Carrier (SC) multiplexing method is essential for a digital coherent optical transmission system that achieves a communication rate of 1 Tbps (Tbps) or higher. In the case of using the digital SC multiplexing method with orthogonal modulation, noise generated by IQ mixing (Inphase and Quadrature mixing) occurs between Inphase (I) and Quadrature (Q) components due to delays, amplitude errors, and frequency characteristic differences. There has been a problem that this noise leads to the degradation of reception characteristics. Specifically, a MIMO (Multi Input Multi Output) equalizer provided on the reception side to compensate for a frequency characteristic difference between the inphase component and the quadrature component derives a filter coefficient of a FIR (Finite Impulse Response) filter while noise due to IQ mixing is included, and thus the reception characteristics are degraded. The inphase component is sometimes referred to as an I lane, while the quadrature component is referred to as a Q lane.

Non Patent Literature 1 discloses that, in wireless communication, the influence of IQ mixing is avoided by periodically alternating the pilot signals of the one-sided subcarriers of Orthogonal Frequency Division Multiplexing (OFDM) to zero, thereby deriving optimal filter coefficients for transmission and reception. Non Patent Literature 1 does not disclose the reduction of noise caused by IQ mixing in a digital coherent optical transmission system employing a plurality of subcarrier multiplexing methods.

In Non Patent Literature 2, in single-carrier digital coherent optical transmission, it is disclosed to compensate for the frequency characteristics of transmission and reception devices using an 8×2 MIMO provided on the reception side. Non Patent Literature 2 does not disclose the reduction of noise caused by IQ mixing in a digital coherent optical transmission system employing a plurality of subcarrier multiplexing methods.

In Non Patent Literature 3, in single-carrier digital coherent optical transmission, it is disclosed to compensate for frequency characteristics of a reception device using a 4×2 MIMO provided on the reception side. Non Patent Literature 3 does not disclose the reduction of noise caused by IQ mixing in a digital coherent optical transmission system employing a plurality of subcarrier multiplexing methods.

### CITATION LIST

### Non Patent Literature

Non Patent Literature 1: M. Sandell et al., “Novel IQ imbalance estimation for wideband MIMO OFDM systems with CFO”, 2019 IEEE Global Communications Conference (GLOBECOM)
Non Patent Literature 2: T. Kobayashi et al., “35-Tb/s C-Band Transmission Over 800 km Employing 1-Tb/s PS-64QAM Signals Enhanced by Complex 8×2 MIMO Equalizer”, 2019 Optical Fiber Communications Conference and Exhibition (OFC) Non Patent Literature 3: Edson Porto da Silva et al., “Widely Linear Equalization for IQ Imbalance and Skew Compensation in Optical Coherent Receivers”, Journal of Lightwave Technology (Volume: 34, Issue: 15, 81, 1 2016)

### SUMMARY OF INVENTION

### Technical Problem

As described above, in the SC multiplexing system used in the digital coherent optical transmission system for high-speed communication, there is a problem that reception characteristics are degraded due to noise caused by IQ mixing generated in the paired subcarriers.

An object of the present disclosure is to provide an optical transmission apparatus, system, method, and non-transitory computer readable medium which solve the aforementioned problem.

### Solution to Problem

An optical transmission apparatus according to the present disclosure includes:
pilot addition means for generating a first digital signal by adding a first pilot signal to a first data signal and generating a second digital signal by adding a second pilot signal to a second data signal; and
optical modulation means for generating an optical modulation signal by optically modulating the first digital signal with a first subcarrier included in a negative frequency band to a center frequency of a used frequency band, optically modulating the second digital signal with a second subcarrier included in a positive frequency band to the center frequency of the used frequency band, and transmitting the optical modulation signal, wherein
the pilot addition means does not transmit the second pilot signal during transmission of the first pilot signal, and
the pilot addition means does not transmit the first pilot signal during transmission of the second pilot signal.

An optical transmission apparatus according to the present disclosure includes:
pilot addition means for generating a first digital signal by adding a first pilot signal to a first data signal, generating a second digital signal by adding a second pilot signal to a second data signal, generating a third digital signal by adding a third pilot signal to a third data signal, and generating a fourth digital signal by adding a fourth pilot signal to a fourth data signal;
optical modulation means for generating an X optical modulation signal by optically modulating the first digital signal in X-polarization using a first subcarrier included in a negative frequency band to a center frequency of a used frequency band and optically modulating the second digital signal in the X-polarization using a second subcarrier included in a positive frequency band to the center frequency of the used frequency band, and generating a Y optical modulation signal by optically modulating the third digital signal in Y-polarization using the first subcarrier and optically modulating the fourth digital signal in the Y-polarization using the second subcarrier, and transmitting the X optical modulation signal and the Y optical modulation signal; and
polarization synthesis means for synthesizing the X optical modulation signal and the Y optical modulation signal, wherein
the pilot addition means does not transmit the second pilot signal and the fourth pilot signal during transmission of the first pilot signal and the third pilot signal, and
the pilot addition means does not transmit the first pilot signal and the third pilot signal during transmission of the second pilot signal and the fourth pilot signal.

An optical transmission apparatus according to the present disclosure includes:
pilot addition means for generating a first digital signal by adding a first pilot signal to a first data signal, generating a second digital signal by adding a second pilot signal to a second data signal, generating a third digital signal by adding a third pilot signal to a third data signal, and generating a fourth digital signal by adding a fourth pilot signal to a fourth data signal; and
optical modulation means for generating an optical modulation signal by optically modulating the first digital signal with a first subcarrier included in a negative frequency band to a center frequency of a used frequency band, optically modulating the second digital signal with a second subcarrier included in a negative frequency band to the center frequency of the used frequency band, optically modulating the third digital signal with a third subcarrier included in a positive frequency band to the center frequency of the used frequency band, and optically modulating the fourth digital signal with a fourth subcarrier included in a positive frequency band to the center frequency of the used frequency band, and transmitting the optical modulation signal, wherein
the pilot addition means does not transmit the third pilot signal and the fourth pilot signal during transmission of the first pilot signal and the second pilot signal, and
the pilot addition means does not transmit the first pilot signal and the second pilot signal during transmission of the third pilot signal and the fourth pilot signal.

A system according to the present disclosure includes:
an optical transmission apparatus; and
another one of the optical transmission apparatus configured to receive an optical modulation signal from the optical transmission apparatus through an optical transmission path, wherein
the optical transmission apparatus includes:
   pilot addition means for generating a first digital signal by adding a first pilot signal to a first data signal and generating a second digital signal by adding a second pilot signal to a second data signal; and
   optical modulation means for generating the optical modulation signal by optically modulating the first digital signal with a first subcarrier included in a negative frequency band to a center frequency of a used frequency band, optically modulating the second digital signal with a second subcarrier included in a positive frequency band to the center frequency of the used frequency band, and transmitting the optical modulation signal,
the pilot addition means does not transmit the second pilot signal during transmission of the first pilot signal, and
the pilot addition means does not transmit the first pilot signal during transmission of the second pilot signal,
the other optical transmission apparatus includes:
optical signal reception means for receiving the first digital signal obtained by coherent detection of the optical modulation signal and the second digital signal obtained by the coherent detection of the optical modulation signal;
position detection means for detecting a position of the first pilot signal within the first digital signal and a position of the second pilot signal within the second digital signal; and
frequency characteristic difference compensation means for compensating for a frequency characteristic difference between an inphase component and a quadrature component of the first data signal and a frequency characteristic difference between an inphase component and a quadrature component of the second data signal using the first pilot signal and the second pilot signal.

A method according to the present disclosure includes:
generating a first digital signal by adding a first pilot signal to a first data signal and generating a second digital signal by adding a second pilot signal to a second data signal;
generating an optical modulation signal by optically modulating the first digital signal with a first subcarrier included in a negative frequency band to a center frequency of a used frequency band, optically modulating the second digital signal with a second subcarrier included in a positive frequency band to the center frequency of the used frequency band, and transmitting the optical modulation signal;
not transmitting the second pilot signal during transmission of the first pilot signal; and
transmitting the first pilot signal during transmission of the second pilot signal.

A non-transitory computer readable medium according to the present disclosure stores a program causes a computer to execute:
generating a first digital signal by adding a first pilot signal to a first data signal and generating a second digital signal by adding a second pilot signal to a second data signal;
generating an optical modulation signal by optically modulating the first digital signal with a first subcarrier included in a negative frequency band to a center frequency of a used frequency band, optically modulating the second digital signal with a second subcarrier included in a positive frequency band to the center frequency of the used frequency band, and transmitting the optical modulation signal;
not transmitting the second pilot signal during transmission of the first pilot signal; and
transmitting the first pilot signal during transmission of the second pilot signal.

### Advantageous Effects of Invention

According to the present disclosure, it is possible to provide an optical transmission apparatus, system, method, and non-transitory computer readable medium that can reduce noise generated due to IQ mixing in a subcarrier multiplexing method.

### BRIEF DESCRIPTION OF DRAWINGS

FIG. 1 is a block diagram showing an example of a digital coherent optical transmission system;

FIG. 2 is a schematic diagram showing an example of a waveform after subcarrier synthesis;

FIG. 3 is a schematic diagram showing an example of a waveform after subcarrier synthesis;

FIG. 4 is a block diagram showing an example of a MIMO equalizer of an optical transmission apparatus and its input/output;

FIG. 5 is a block diagram showing an example of an optical transmission apparatus according to a first example embodiment;

FIG. 6 is a block diagram showing an example of the optical transmission apparatus according to the first example embodiment;

FIG. 7 is a block diagram showing an example of the optical transmission apparatus according to the first example embodiment;

FIG. 8 is a block diagram showing an example of a system according to the first example embodiment;

FIG. 9 is a block diagram showing an example of a MIMO equalizer according to the first example embodiment;

FIG. 10 is a schematic diagram showing an example of a state of transmission of pilot signals according to the first example embodiment;

FIG. 11 is a schematic diagram showing an example of a MIMO equalizer and its input/output of the optical transmission apparatus according to the first example embodiment;

FIG. 12 is a schematic diagram showing an example of a MIMO equalizer and its input/output of the optical transmission apparatus according to the first example embodiment;

FIG. 13 is a block diagram showing an example of a MIMO equalizer according to the first example embodiment;

FIG. 14 is a block diagram showing an example of a MIMO equalizer according to the first example embodiment;

FIG. 15 is a block diagram showing an example of a 2×2 MIMO equalizer according to a second example embodiment;

FIG. 16 is a block diagram showing an example of a 4×2 MIMO equalizer according to a third example embodiment;

FIG. 17 is a block diagram showing an example of a 4×2 MIMO equalizer according to a fourth example embodiment;

FIG. 18 is a schematic diagram showing an example of a part of reception means of an optical transmission apparatus according to a fifth example embodiment;

FIG. 19 is a schematic diagram showing an example of a part of transmission means of the optical transmission apparatus according to the fifth example embodiment;

FIG. 20 is a schematic diagram showing an example of a part of reception means of an optical transmission apparatus according to a sixth example embodiment;

FIG. 21 is a schematic diagram showing an example of a part of transmission means of the optical transmission apparatus according to the sixth example embodiment;

FIG. 22 is a schematic diagram showing an example of a state of transmitting pilot signals according to a seventh example embodiment;

FIG. 23 is a schematic diagram showing an example of a state of transmitting pilot signals according to the seventh example embodiment; and

FIG. 24 is a schematic diagram showing an example of a state of transmitting pilot signals according to the seventh example embodiment.

### EXAMPLE EMBODIMENT

Hereinafter, example embodiments of the present disclosure will be described with reference to the drawings. In each drawing, the same or corresponding elements are assigned the same reference signs, and repeated descriptions will be omitted as necessary for clarity.

### Problem to be Solved

First, details of the problem to be solved will be described.

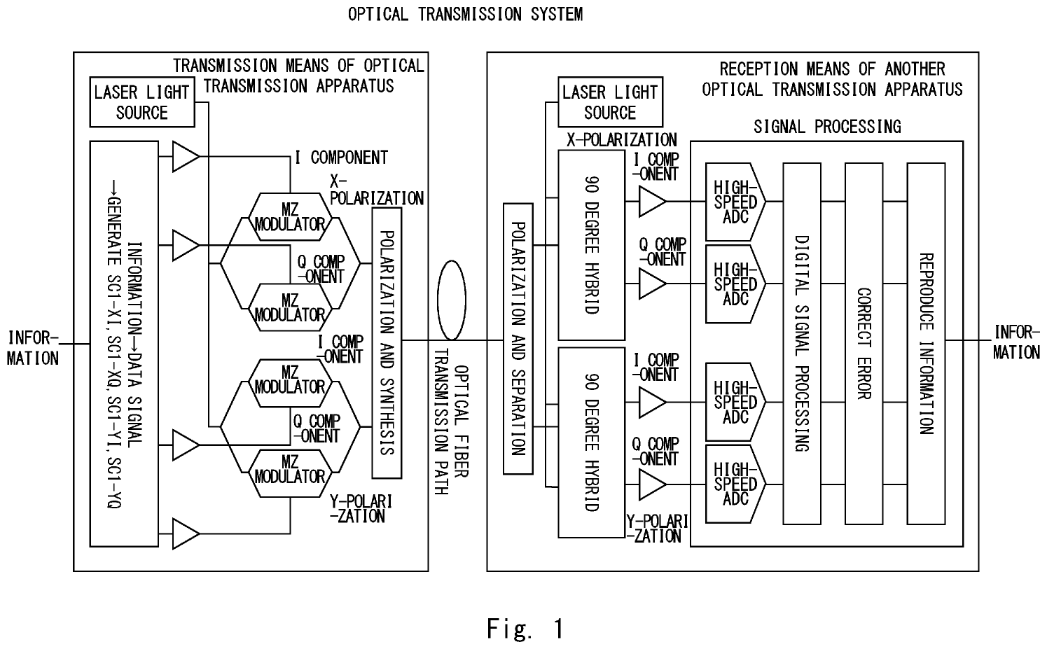

FIG. 1 is a block diagram showing an example of a digital coherent optical transmission system.

As shown in FIG. 1, transmission means of an optical transmission apparatus of the optical transmission system generates data signals by performing processing such as encoding on the information to be transmitted. Transmission means of the optical transmission apparatus generates I component SC1-XI of X-polarization of a first subcarrier and Q component SC1-XQ of X-polarization of a first subcarrier, as well as I component SC1-YI Y-polarization of the first subcarrier and Q component SC1-YQ of Y-polarization of the first subcarrier, from the data signals. The transmission means of the optical transmission apparatus optically modulates each of these components using a Mach-Zender (MZ) modulator to generate an optical modulation signal. The transmission means of the optical transmission apparatus polarizes and synthesizes these generated optical modulation signals and transmits them to another optical transmission apparatus through an optical transmission path. Additionally, the I component is sometimes referred to as an inphase component, and the Q component is sometimes referred to as a quadrature component. The optical transmission path is also referred to as an optical fiber at times.

The reception means of the other optical transmission apparatus polarizes and separates the optical modulation signal received from the optical transmission apparatus, and then converts it into the I component of the X-polarization of the first subcarrier and the Q component of the X-polarization of the first subcarrier using the other 90 degree hybrid. The reception means of the other optical transmission apparatus converts the optical modulation signal into the I component of the Y-polarization of the first subcarrier and the Q component of the Y-polarization of the first subcarrier using another 90 degree hybrid. The reception means of the other optical transmission apparatus converts these converted components (signals) into electrical signals by coherent detection, and samples these electrical signals using a high-speed Analog Digital Converter (ADC). The reception means of the optical transmission apparatus digitally processes the sampled signals to correct waveform distortions. In digital signal processing, waveform distortions are corrected using a MIMO equalizer mentioned later. The reception means of the optical transmission apparatus performs error correction on the corrected data and reproduces the information.

Here, the influence of IQ mixing occurring in the transmission means of the optical transmission apparatus will be explained.

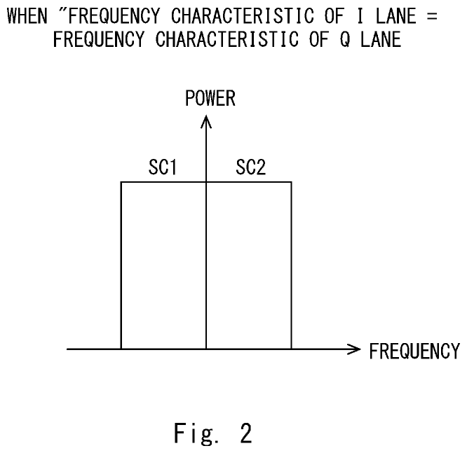

FIG. 2 is a schematic diagram showing an example of a waveform after subcarrier synthesis.

FIG. 2 shows a waveform after a first subcarrier and a second subcarrier are synthesized.

FIG. 2 shows a case where a frequency characteristic of an I lane=a frequency characteristic of a Q lane.

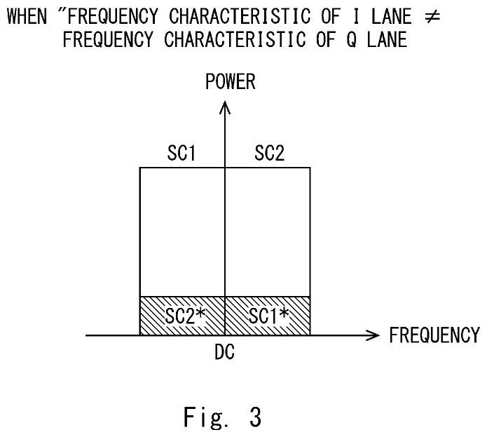

FIG. 3 is a schematic diagram showing an example of a waveform after subcarrier synthesis.

FIG. 3 shows a waveform after the first subcarrier and the second subcarrier are synthesized.

FIG. 3 shows a case where the frequency characteristic of the I lane #the frequency characteristic of the Q lane.

The horizontal axis shown in FIGS. 2 and 3 represents frequency, and the vertical axis represents power.

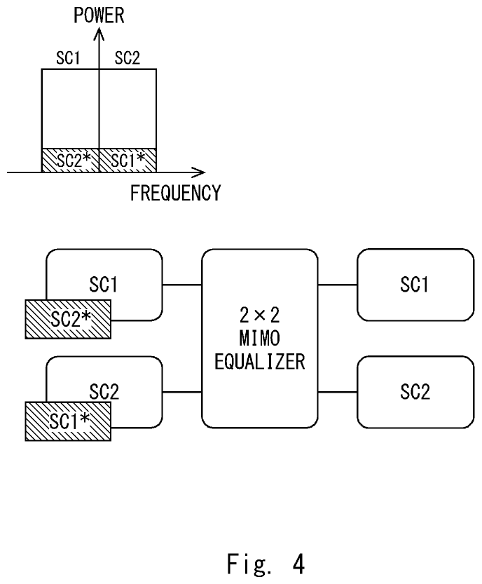

FIG. 4 is a block diagram showing an example of the MIMO equalizer of the optical transmission apparatus and its input/output.

As shown in FIG. 2, when the frequency characteristic of the I lane=the frequency characteristic of the Q lane, that is, when there is no difference between the frequency characteristic of the I lane and the frequency characteristic of the Q lane, there is no influence of IQ mixing.

On the other hand, as shown in FIG. 3, when the frequency characteristic of the I lane #the frequency characteristic of the Q lane, that is, when there is a difference between the frequency characteristics of the I lane and the frequency characteristics of the Q lane, a conjugate component SC2* of the second subcarrier is generated in the first subcarrier SC1 by IQ mixing. In addition, a conjugate component SC1* of the first subcarrier occurs in the second subcarrier SC2 by IQ mixing. That is, IQ mixing occurs due to each other's conjugate components of the subcarriers SCs. Note that IQ mixing occurs between the paired subcarriers SCs (which are the first subcarrier SC1 and the second subcarrier SC2 in FIG. 3) due to the difference in delay, amplitude, frequency characteristics, etc. between the I lane and the Q lane.

As a result of IQ mixing, the conjugate component SC2* of the second subcarrier and the conjugate component SC1* of the first subcarrier are generated. Consequently, an input to the MIMO equalizer is a signal having a waveform as shown in FIG. 4. Here, for the MIMO equalizer, the conjugate component SC2* of the second subcarrier and the conjugate component SC1* of the first subcarrier cause interference or noise. The MIMO equalizer is a device for compensating for the frequency characteristic difference between the IQs of receivers of optical transmission apparatuses. Therefore, in an environment where noise is input to the MIMO equalizer, it is difficult to compensate for the frequency characteristic difference between the IQs of receivers using the MIMO equalizer.

In an environment where noise is contained due to IQ mixing, it is difficult to derive an optimal filter coefficient of the MIMO equalizer, resulting in degradation in the reception characteristics. In other words, since the filter coefficient does not converge to an optimal value, the reception characteristics are degraded.

Therefore, in the first example embodiment, even when the conjugate component SC2* of the second subcarrier and the conjugate component SC1* of the first subcarrier are generated by IQ mixing, the MIMO equalizer is prevented from being affected by them. A specific configuration for preventing the MIMO equalizer from being affected by IQ mixing will be described in the first example embodiment.

### First Example Embodiment

### <Configuration of Apparatus: 2SC Configuration (Minimum Configuration)>

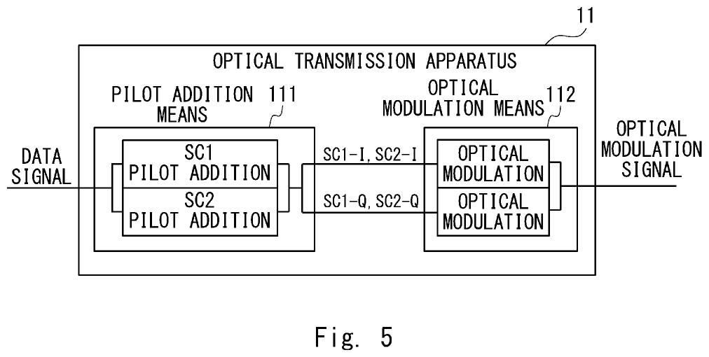

FIG. 5 is a block diagram showing an example of an optical transmission apparatus according to the first example embodiment.

FIG. 5 shows a minimum configuration of the optical transmission apparatus according to the first example embodiment.

FIG. 5 shows only a configuration of transmission means of an optical transmission apparatus for simplicity.

As shown in FIG. 5, an optical transmission apparatus 11 according to the first example embodiment includes pilot addition means 111 and optical modulation means 112.

The pilot addition means 111 adds (inserts) a first pilot signal to a first data signal to generate a first digital signal, and adds (inserts) a second pilot signal to a second data signal to generate a second digital signal.

The optical transmission apparatus 11 may include data signal generation means for generating a data signal by performing processing such as encoding on the information to be transmitted. The data signal includes a first data signal and a second data signal. The pilot addition means is sometimes referred to as pilot insertion means. The first pilot signal and the second pilot signal are sometimes collectively referred to as a pilot signal. The pilot signal is a known signal required to reproduce the data signal.

The optical modulation means 112 optically modulates a digital subcarrier multiplexed signal as follows.

The optical modulation means 112 generates an optical modulation signal by optically modulating the first digital signal with the first subcarrier SC1 included in a negative frequency band to a center frequency of a used frequency band and optically modulating the second digital signal with the second subcarrier SC2 included in a positive frequency band to the center frequency of the used frequency band. Specifically, the optical modulation means 112 generates an optical modulation signal by optically modulating an inphase component SC1-I and a quadrature component SC1-Q of the first digital signal with the first subcarrier SC1, and optically modulating an inphase component SC2-I and a quadrature component SC2-Q of the second digital signal with the second subcarrier SC2. After that, the optical modulation means 112 transmits the generated optical modulation signal. The negative frequency band to the center frequency indicates a frequency band lower than the center frequency. The positive frequency band to the center frequency indicates a frequency band higher than or equal to the center frequency.

The optical modulation means 112 may optically modulate each of the first digital signal and the second digital signal using either a phase modulation method or an orthogonal modulation method.

The optical modulation means 112 may optically modulate digital signals by means of a Mach-Zender (MZ) modulator.

The pilot addition means 111 does not transmit the second pilot signal during the transmission of the first pilot signal. The pilot addition means 111 does not transmit the first pilot signal during the transmission of the second pilot signal.

Thus, the conjugate component SC2* of the second subcarrier due to IQ mixing does not occur during the transmission of the first pilot signal of the first subcarrier SC1. Similarly, the conjugate component SC1* of the first subcarrier due to IQ mixing does not occur during the transmission of the second pilot signal of the second subcarrier SC2. As a result, under an environment in which interference or noise (conjugate component SC2* of the second subcarrier or conjugate component SC1* of the first subcarrier) does not occur, the MIMO equalizer can derive an optimal filter coefficient, and thus the reception characteristics are not degraded.

As a result, according to the first example embodiment, it is possible to provide an optical transmission apparatus, system, method, and non-transitory computer readable medium that can reduce noise generated due to IQ mixing in a subcarrier multiplexing method.

The optical transmission apparatus 11 may include first IQ conversion means for converting the first digital signal into an inphase component and a quadrature component, and second IQ conversion means for converting the second digital signal into an inphase component and a quadrature component. Here, the optical modulation means 112 generates an optical modulation signal by optically modulating the inphase component and quadrature component of the first digital signal with the first subcarrier SC1, and optically modulating the inphase component and quadrature component of the second digital signal with the second subcarrier SC2.

The optical transmission apparatus 11 may also include subcarrier generation means for generating a plurality of subcarriers. Here, the first subcarrier SC1 and the second subcarrier SC2 may be selected from among the plurality of subcarriers.

The optical modulation means 112 of the optical transmission apparatus 11 may further include optical signal synthesis means for synthesizing the inphase component and the quadrature component of the optical modulation signal generated after optical modulation.

The optical transmission apparatus 11 may also include pilot signal generation means for generating the first pilot signal and the second pilot signal.

The pilot addition means 111 may alternately transmit the first pilot signal and the second pilot signal.

The pilot addition means 111 may determine a duration of the transmission time for transmitting the first data signal and a duration of the transmission time for transmitting the first pilot signal based on a data volume of the first data signal. For example, when the data volume of the first data signal is larger than the data volume of the first pilot signal, the pilot addition means 111 extends the duration of the transmission time for transmitting the first data signal beyond that of the first pilot signal.

### <Configuration of Apparatus: 2SC XY-Polarization Configuration>

The case of the XY-polarization configuration for two subcarriers will be described.

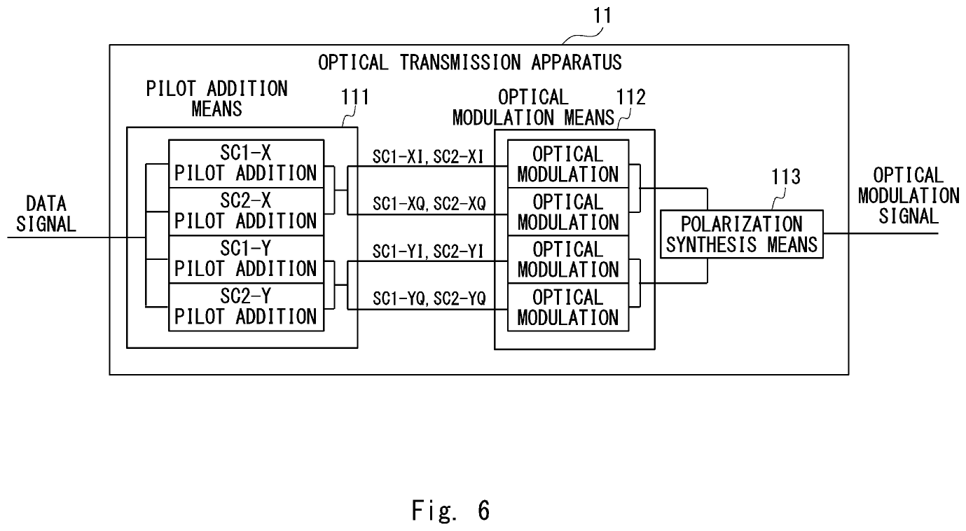

FIG. 6 is a block diagram showing an example of the optical transmission apparatus according to the first example embodiment.

FIG. 6 shows an XY-polarization configuration of 2SC in the optical transmission apparatus according to the first example embodiment.

FIG. 6 shows only a configuration of a transmission unit of the optical transmission apparatus for simplicity.

As shown in FIG. 6, the optical transmission apparatus 11 having a 2SC XY-polarization configuration includes the pilot addition means 111, the optical modulation means 112, and the polarization synthesis means 113.

The pilot addition means 111 adds the first pilot signal to the first data signal to generate the first digital signal, and adds the second pilot signal to the second data signal to generate the second digital signal. The pilot addition means 111 adds a third pilot signal to a third data signal to generate a third digital signal, and adds a fourth pilot signal to a fourth data signal to generate a fourth digital signal.

The optical modulation means 112 generate an X optical modulation signal by optically modulating the first digital signal with X-polarization using the first subcarrier SC1 included in the negative frequency band to the center frequency of the used frequency band, and optically modulating the second digital signal with X-polarization using the second subcarrier SC2 included in the positive frequency band to the center frequency of the used frequency band. Specifically, the optical modulation means 112 generates an optical modulation signal by optically modulating an inphase component SC1-XI and a quadrature component SC1-XQ of the first digital signal with X-polarization using the first subcarrier SC1, and optically modulating an inphase component SC2-XI and a quadrature component SC2-XQ of the second digital signal with X-polarization using the second subcarrier SC2.

The optical modulation means 112 generate a Y optical modulation signal by optically modulating the third digital signal with Y-polarization using the first subcarrier SC1 included in the negative frequency band to the center frequency of the used frequency band, and optically modulating the fourth digital signal with Y-polarization using the second subcarrier SC2 included in the positive frequency band to the center frequency of the used frequency band. Specifically, the optical modulation means 112 generates an optical modulation signal by optically modulating an inphase component SC1-YI and a quadrature component SC1-YQ of the third digital signal with Y-polarization using the first subcarrier SC1, and optically modulating an inphase component SC2-YI and a quadrature component SC2-YQ of the fourth digital signal with Y-polarization using the second subcarrier SC2.

The optical modulation means 112 transmits the generated X optical modulation signal and the Y optical modulation signal. The polarization synthesis means 113 synthesizes the X optical modulation signal and the Y optical modulation signal.

The pilot addition means 111 does not transmit the second pilot signal and the fourth pilot signal during the transmission of the first pilot signal and the third pilot signal. The pilot addition means 111 does not transmit the first pilot signal and the third pilot signal during the transmission of the second pilot signal and the fourth pilot signal.

### <Configuration of Apparatus: 4SC Configuration>

The case of a four-subcarrier configuration will be described below.

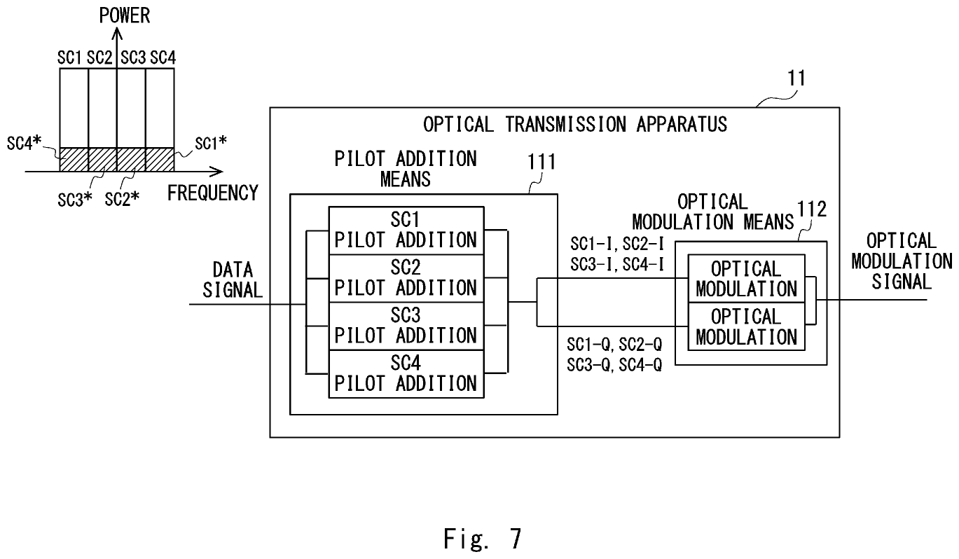

FIG. 7 is a block diagram showing an example of the optical transmission apparatus according to the first example embodiment.

FIG. 7 shows a 4SC configuration of the optical transmission apparatus according to the first example embodiment.

FIG. 7 shows only a configuration of a transmission unit of the optical transmission apparatus for simplicity.

As shown in FIG. 7, the optical transmission apparatus 11 of 4SC includes the pilot addition means 111 and the optical modulation means 112.

The pilot addition means 111 adds the first pilot signal to the first data signal to generate the first digital signal, and adds the second pilot signal to the second data signal to generate the second digital signal. The pilot addition means 111 adds the third pilot signal to the third data signal to generate the third digital signal, and adds the fourth pilot signal to the fourth data signal to generate the fourth digital signal.

The optical modulation means 112 optically modulates the first digital signal with the first subcarrier SC1 included in the negative frequency band to the center frequency of the used frequency band, optically modulates the second digital signal with the second subcarrier SC2 included in the negative frequency band to the center frequency of the used frequency band, optically modulates the third digital signal with a third subcarrier SC3 included in the positive frequency band to the center frequency of the used frequency band, and optically modulates a fourth digital signal with a fourth subcarrier SC4 included in the positive frequency band to the center frequency of the used frequency band to generate an optical modulation signal.

Specifically, the optical modulation means 112 optically modulates the inphase component SC1-I and the quadrature component SC1-Q of the first digital signal with the first subcarrier SC1, optically modulates the inphase component SC2-I and the quadrature component SC2-Q of the second digital signal with the second subcarrier SC2, optically modulates an inphase component SC3-I and a quadrature component SC3-Q of the third digital signal with the third subcarrier SC3, and optically modulates an inphase component SC4-I and a quadrature component SC4-Q of the fourth digital signal with the fourth subcarrier SC4 to generate an optical modulation signal.

The optical modulation means 112 transmits the generated optical modulation signal.

The pilot addition means 111 does not transmit the third pilot signal and the fourth pilot signal during the transmission of the first pilot signal and the second pilot signal. The pilot addition means 111 does not transmit the first pilot signal and the second pilot signal during the transmission of the third pilot signal and the fourth pilot signal.

### <System Configuration>

A system configuration will be described.

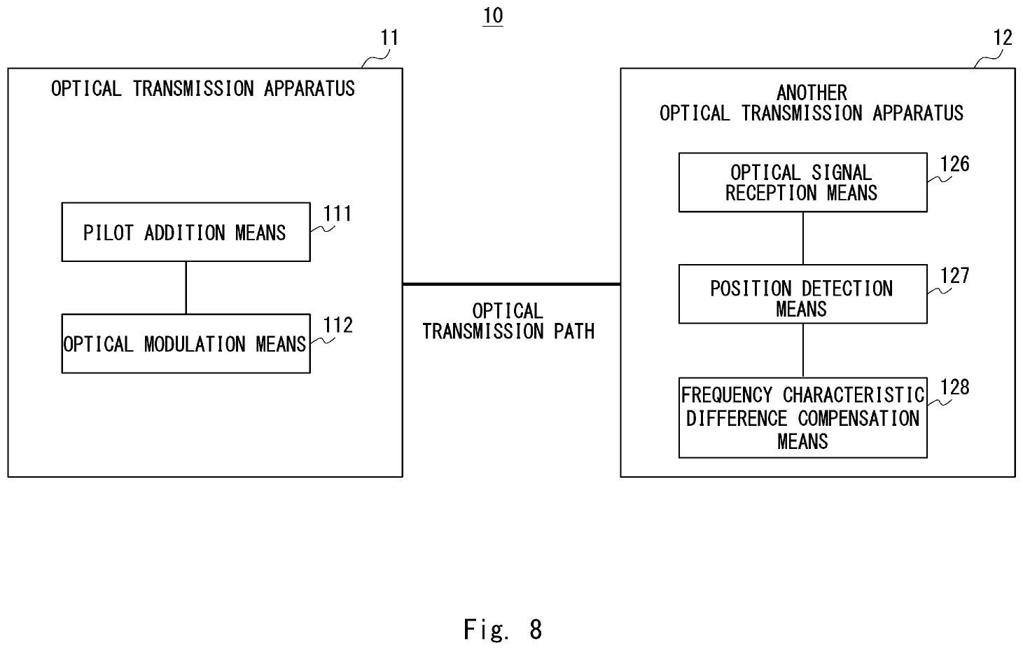

FIG. 8 is a block diagram showing an example of a system according to the first example embodiment.

As shown in FIG. 8, a system 10 includes the optical transmission apparatus 11 and the other optical transmission apparatus 12 that receives an optical modulation signal from the optical transmission apparatus 11 through an optical transmission line. Since the optical transmission apparatus 11 has already been described, further explanation is omitted. The optical transmission apparatus and the other optical transmission apparatus have the same function. The system is sometimes referred to as an optical transmission system.

In describing the system, an optical modulation signal is transmitted from the optical transmission apparatus 11 to the other optical transmission apparatus 12. In this case, for simplicity, the description will focus on explaining only the transmission means of the optical transmission apparatus 11 and only the reception means of the other optical transmission apparatus 12.

The other optical transmission apparatus 12 includes optical signal reception means 126, position detection means 127, and frequency characteristic difference compensation means 128.

The optical signal reception means 126 receives a first digital signal obtained by coherently detecting the optical modulation signal and a second digital signal obtained by coherently detecting the optical modulation signal.

The position detection means 127 detects a position of the first pilot signal within the first digital signal and a position of the second pilot signal within the second digital signal.

The frequency characteristic difference compensation means 128 compensates for the frequency characteristic difference between the inphase component and the quadrature component of the first data signal using the first pilot signal.

The frequency characteristic difference compensation means 128 compensates for the frequency characteristic difference between the inphase component and the quadrature component of the second data signal using the second pilot signal.

The frequency characteristic difference compensation means 128 has a MIMO (Multi Input Multi Output) equalizer for obtaining the frequency characteristic difference and compensating for it based on the frequency characteristic difference. The MIMO equalizer compensates for the frequency characteristic difference between the inphase component and the quadrature component.

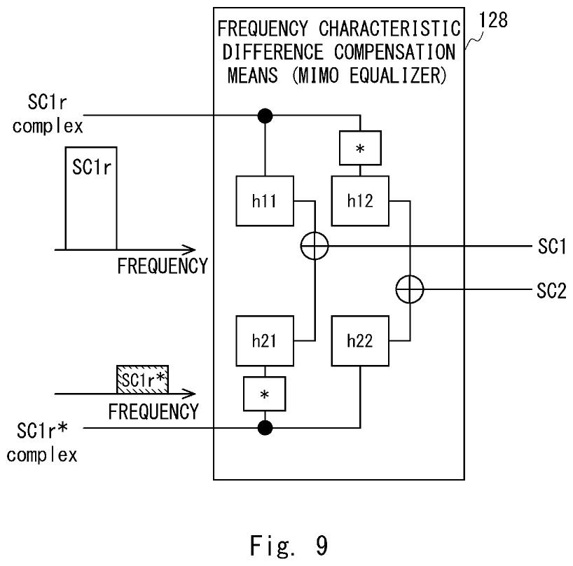

FIG. 9 is a block diagram showing an example of a MIMO equalizer according to the first example embodiment.

FIG. 9 shows a 2×2 MIMO equalizer.

FIG. 9 shows a case where the first subcarrier SC1 is on and the second subcarrier SC2 is off.

As shown in FIG. 9, the frequency characteristic difference compensation means 128 has a MIMO (Multi Input Multi Output) equalizer. The MIMO equalizer has a plurality of FIR (Finite Impulse Response) filters for compensating for the frequency characteristic difference. Each of the plurality of FIR filters has a filter coefficient. h₁₁, h₁₂, h₂₁, and h₂₂ represent the filter coefficients of the FIR filters.

The frequency characteristic difference compensation means 128 detects the frequency characteristic difference of the pilot signal using the MIMO equalizer. The frequency characteristic difference compensation means 128 compensates for the frequency characteristic difference of the data signal based on the detected frequency characteristic difference using, for example, the MIMO equalizer.

The frequency characteristic difference between the inphase component and the quadrature component (IQ) is mainly caused by a device (component) mounted on the optical transmission apparatus. As a result, the variation period of the frequency characteristic difference is in minutes or hours. Therefore, an adaptive equalizer such as a MIMO equalizer is not necessary, and an equalizer with a fixed filter coefficient (fixed equalizer) may be used.

Therefore, the frequency characteristic difference compensation means 128 may use the MIMO equalizer to obtain a predetermined filter coefficient in advance before the operation of the system. The frequency characteristic difference compensation means 128 may obtain a predetermined filter coefficient during the operation of the system. The MIMO equalizer using a predetermined filter coefficient obtained in advance in this way is referred to as a fixed equalizer.

The frequency characteristic difference compensation means 128 may detect the frequency characteristic difference by operating the MIMO equalizer using the predetermined filter coefficient obtained in advance. The frequency characteristic difference compensation means 128 compensates for the frequency characteristic difference of the data signal based on the detected frequency characteristic difference.

### <Operation>

The operation of the optical transmission apparatus according to the first example embodiment will be described below.

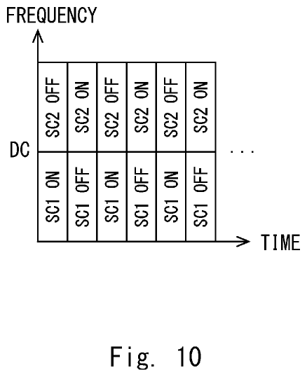

FIG. 10 is a schematic diagram showing an example of a state of transmission of pilot signals according to the first example embodiment.

In FIG. 10, the horizontal axis represents time, and the vertical axis represents frequency.

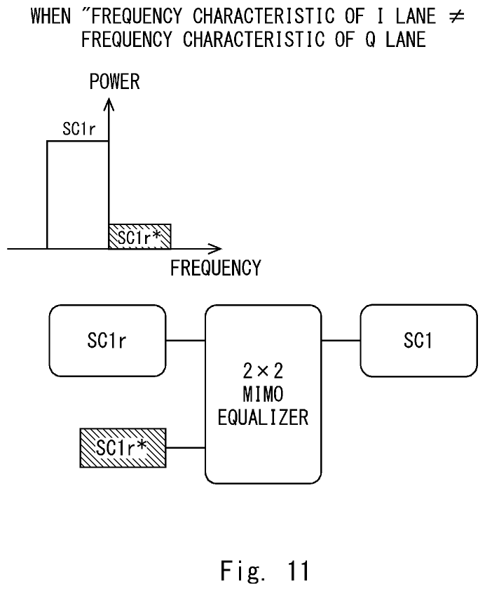

FIG. 11 is a schematic diagram showing an example of a MIMO equalizer and its input/output of the optical transmission apparatus according to the first example embodiment.

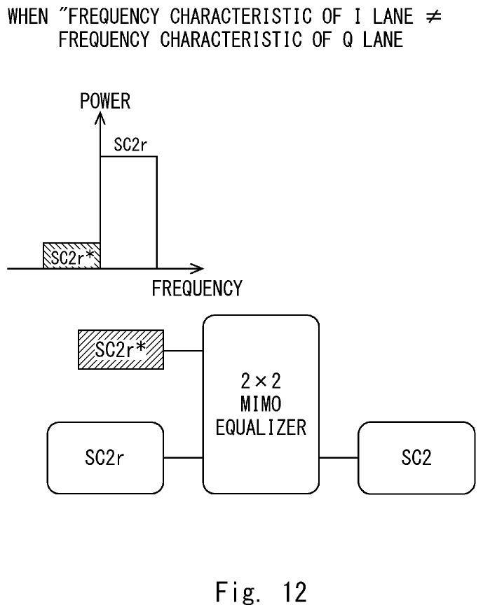

FIG. 11 shows a state when the first pilot signal is transmitted FIG. 12 is a schematic diagram showing an example of a MIMO equalizer of the optical transmission apparatus according to the first example embodiment and its input/output.

FIG. 12 shows a state when the second pilot signal is transmitted.

IQ mixing occurs between paired subcarrier SCs, such as the first subcarrier SC1 and the second subcarrier SC2, with DC as the center (refer to FIG. 3).

In order to reduce the influence of IQ mixing, the optical transmission apparatus 11 according to the first example embodiment does not transmit the second pilot signal of the second subcarrier SC2 during the transmission of the first pilot signal of the first subcarrier SC1, as shown in FIG. 10. The optical transmission apparatus 11 does not transmit the first pilot signal of the first subcarrier SC1 during the transmission of the second pilot signal of the second subcarrier SC2. In other words, the optical transmission apparatus 11 generates a subcarrier multiplexed signal in which a pair of subcarriers SC (the first subcarrier SC1 and the second subcarrier SC2) symmetrically positioned around DC on the frequency axis are alternately set to zero on the time axis and then transmits it.

Note that the number of subcarriers SC is not limited to 2. The number of subcarrier SCs may be any number other than 2 as long as it is an even multiple of 2.

By the optical transmission apparatus 11 periodically alternating the pilot signal of one subcarrier SC to zero, as shown in FIG. 11, the received first subcarrier SC1r does not include the conjugate of the second subcarrier SC2, represented as SC2r*. Similarly, as shown in FIG. 12, the received second subcarrier SC2r does not include the conjugate of the first subcarrier SC1, represented as SC1r*.

As a result, in the reception unit of the optical transmission apparatus, when the filter coefficient of the MIMO equalizer is derived to compensate for the frequency characteristic difference between the inphase and quadrature components (I lane and Q lane), the influence of IQ mixing is avoided. This allows for the derivation of an optimal filter coefficient.

As a result, according to the first example embodiment, it is possible to provide an optical transmission apparatus, system, method, and non-transitory computer readable medium that can reduce noise generated due to IQ mixing in a subcarrier multiplexing method.

The pilot signal may be periodically inserted into the data signal. The optical transmission apparatus 11 may sequentially update the filter coefficient of the MIMO equalizer using the pilot signal. Since the transmission time of the pilot signal is fixed within the total transmission time, the transmission capacity of the data signal does not change even if the transmission of the pilot signal of one subcarrier SC is turned off.

### <Specific Example of MIMO Equalizer>

### <2×2MIMO>

Here, a specific example of a MIMO equalizer provided in the other optical transmission apparatus 12 (which may be the optical transmission apparatus 11) will be described. A 2×2 MIMO will be described.

As shown in FIG. 9, to the MIMO equalizer of the frequency characteristic difference compensation means 128, the first subcarrier SC1r and the conjugate SC1r* of the first subcarrier received by the other optical transmission apparatus 12 are input. In the first example embodiment, the second subcarrier SC2 is not transmitted during the transmission of the first subcarrier SC1 (see FIG. 10). Therefore, the second subcarrier SC2r and the conjugate SC2r* of the second subcarrier are not input to the MIMO equalizer.

The MIMO equalizer compensates for the frequency characteristic difference between the IQs of the receiver (reception unit) of the other optical transmission apparatus 12. The MIMO equalizer compensates for the frequency characteristic difference between the IQs based on the pilot signal included in the received first subcarrier SC1r.

The relationship between the first subcarrier SC1 and the received subcarrier SC1r is shown in Expression 1. The relationship between the second subcarrier SC2 and the received subcarrier SC1r is shown in Expression 2. Note that h₁₁, h₂₁, h₁₂, and h₂₂ indicate the filter coefficients of the FIR filters of the MIMO equalizer. Since the first subcarrier SC1 is on and the second subcarrier SC2 is off, SC2=0.

$$SC 1 = {h}_{11} SC 1 r + {h}_{21} SC 1 {r}^{**} \qquad ( Expression 1 )$$

$$SC 2 = {h}_{12} SC 1 {r}^{*} + {h}_{22} SC 1 {r}^{*} = 0 \qquad ( Expression 2 )$$

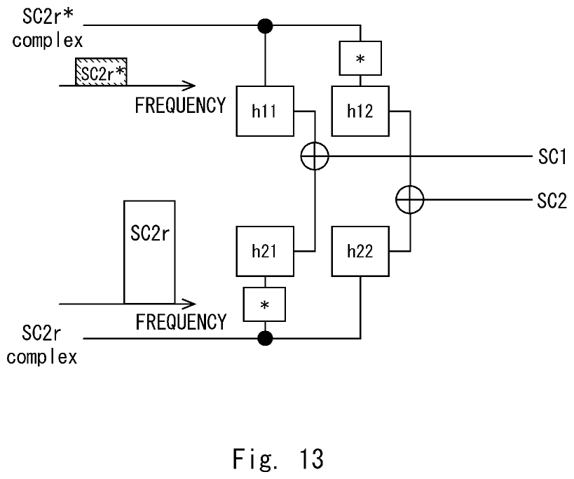

FIG. 13 is a block diagram showing an example of a MIMO equalizer according to the first example embodiment.

FIG. 13 shows a 2×2 MIMO equalizer.

FIG. 13 shows a case where the first subcarrier SC1 is off and the second subcarrier SC2 is on.

As shown in FIG. 13, the second subcarrier SC2r and the conjugate SC2r* of the second subcarrier received by the other optical transmission apparatus 12 are input to the MIMO equalizer. In the first example embodiment, the first subcarrier SC1 is not transmitted during the transmission of the second subcarrier SC2 (see FIG. 10). Therefore, the first subcarrier SC1r and the conjugate SC1r* of the first subcarrier are not input to the MIMO equalizer.

The MIMO equalizer compensates for the frequency characteristic difference between the IQs of the receiver (reception unit) of the other optical transmission apparatus 12. The MIMO equalizer compensates for the frequency characteristic difference between the IQs based on the pilot signal included in the received second subcarrier SC2r.

The relationship between the first subcarrier SC1 and the received subcarrier SC1r is shown in Expression 3. The relationship between the second subcarrier SC2 and the received subcarrier SC2r is shown in Expression 4. Since the first subcarrier SC1 is off and the second subcarrier SC2 is on, SC1=0.

$$SC 1 = {h}_{11} SC 2 {r}^{*} + {h}_{21} SC 2 {r}^{*} = 0 \qquad ( Expression 3 )$$

$$SC 2 = {h}_{12} SC 2 {r}^{**} + {h}_{22} SC 2 r \qquad ( Expression 4 )$$

The MIMO equalizer obtains the filter coefficients of the FIR filters based on Expressions 1, 2, 3, and 4. The MIMO equalizer compensates for the frequency characteristic difference between the IQs of the reception means using the obtained filter coefficients of the FIR filters.

### <4×4MIMO>

A 4×4 MIMO is explained.

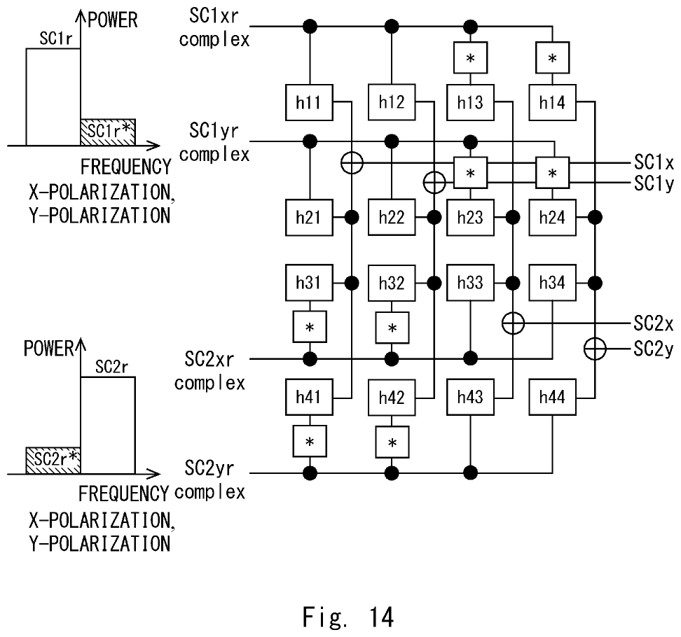

FIG. 14 is a block diagram showing an example of a MIMO equalizer according to the first example embodiment.

FIG. 14 shows a 4×4 MIMO equalizer in the case of polarization multiplexing with XY-polarization.

As shown in FIG. 14, the MIMO equalizer receives inputs during predetermined periods as follows: during one period, the X-polarization SC1xr of the first subcarrier, the Y-polarization SC1yr of the first subcarrier, the conjugate SC2xr* of the X-polarization of the second subcarrier, and the conjugate SC2yr*of the Y-polarization of the second subcarrier. In another period, the MIMO equalizer receives inputs as follows: the conjugate SC1xr* of the X-polarization of the first subcarrier, the conjugate SC1yr*of the Y-polarization of the first subcarrier, the X-polarization SC2xr of the second subcarrier, and the Y-polarization SC2yr of the second subcarrier.

The relationship between the X-polarization SC1x of the first subcarrier and the received subcarrier (SC1xr, SC1yr, SC2xr*, SC2yr*) is shown in Expression 5. The relationship between the Y-polarization SC1y of the first subcarrier and the received subcarrier is shown in Expression 6. The relationship between the X-polarization SC2x of the second subcarrier and the received subcarrier is shown in Expression 7. The relationship between the Y-polarization SC2y of the second subcarrier and the received subcarrier is shown in Expression 8. Note that h₁₁ to h₄₄ indicate the filter coefficients of the FIR filters of the MIMO equalizer.

$$SC 1 x = {h}_{11} SC 1 xr + {h}_{21} SC 1 y r + {h}_{31} SC 2 {xr}^{*} + {h}_{41} SC 2 y {r}^{*} \qquad ( Expression 5 )$$

$$SC 1 y = {h}_{12} SC 1 xr + {h}_{22} SC 1 y r + {h}_{32} SC 2 {xr}^{*} + {h}_{42} SC 2 y {r}^{*} \qquad ( Expression 6 )$$

$$SC 2 x = {h}_{13} SC 1 {xr}^{*} + {h}_{23} SC 1 y {r}^{*} + {h}_{33} SC 2 xr + {h}_{43} SC 2 y r \qquad ( Expression 7 )$$

$$SC 2 y = {h}_{14} SC 1 {xr}^{*} + {h}_{24} SC 1 y {r}^{*} + {h}_{34} SC 2 xr + {h}_{44} SC 2 y r \qquad ( Expression 8 )$$

In the first example embodiment, the X-polarization carrier and Y-polarization subcarrier form a pair. The pilot signals of the X-polarization and Y-polarization subcarriers SC are controlled to be turned on and off simultaneously. Specifically, the X-polarization SC1x of the first subcarrier and Y-polarization SC1y of the first subcarrier are turned on, while the X-polarization SC2x of the second subcarrier and Y-polarization SC2y of the second subcarrier are turned off. Similarly, the X-polarization SC1x of the first subcarrier and Y-polarization SC1y of the first subcarrier are turned off, and the X-polarization SC2x of the second subcarrier and Y-polarization SC2y of the second subcarrier are turned on. Note that IQ mixing occurs between the I and Q components within X-polarization and between the I and Q components within Y-polarization, so the on/off states for X and Y-polarizations may be independently controlled. Specifically, the X-polarization SC1x of the first subcarrier is on while the X-polarization SC2x of the second subcarrier is off. Similarly, the Y-polarization SC1y of the first subcarrier is on while the Y-polarization SC2y of the second subcarrier is off. The conditions for the on/off states of the subcarriers are not limited to the above conditions. For instance, it is also possible to turn on any one subcarrier while turning off all the other subcarriers.

The MIMO equalizer obtains the filter coefficients of the FIR filters based on Expressions 5, 6, 7, 8, and the conditions for the on/off states of the subcarrier. The MIMO equalizer uses the obtained filter coefficients of the FIR filters to compensate for the frequency characteristic difference between the IQs of the reception unit.

As described above, by using a 4×4 MIMO equalizer, it becomes possible to support XY polarization multiplexing. Moreover, the number of subcarriers SC can be an integer multiple of 2 (2, 4, 6, . . . ). In such cases, a 2×2 MIMO is employed for each set of subcarriers SC. For instance, when there are two subcarriers, a single set of 2×2 MIMO is used, and when there are four subcarriers, two sets of 2×2 MIMO are used.

### Second Example Embodiment

A system 20 according to a second example embodiment differs from the system 10 according to the first example embodiment in that, in the system 20, the other optical transmission apparatus 12 has light source error compensation means. The light source error compensation means compensates for frequency errors between a light source for modulation included in the optical transmission apparatus 11 to perform optical modulation and a light source for detection included in the other optical transmission apparatus 12 for coherent detection.

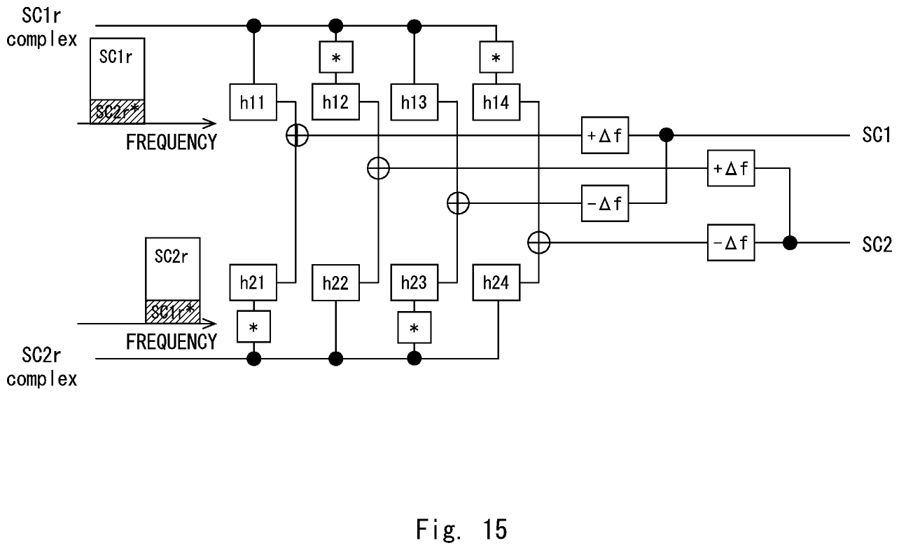

FIG. 15 is a block diagram showing an example of a 2×2 MIMO equalizer according to the second example embodiment.

The 2×2 MIMO equalizer according to the second example embodiment includes frequency error detection means, compensation means, and the light source error compensation means.

The relationship between the first subcarrier SC1 and the received subcarrier (SC1r, SC2r*) is shown in Expression 9. The relationship between the second subcarrier SC2 and the received subcarrier (SC1r*, SC2r) is shown in Expression 9.

$$SC 1 = ( Δ {fh}_{11} - Δ {fh}_{13} ) SC 1 r + ( Δ {fh}_{21} - Δ {fh}_{23} ) SC 2 {r}^{*} \qquad ( Expression 9 )$$

$$SC 2 = ( Δ {fh}_{12} - Δ {fh}_{14} ) SC 1 {r}^{*} + ( Δ {fh}_{22} - Δ {fh}_{24} ) SC 2 r \qquad ( Expression 10 )$$

Note that Δf indicates a frequency error between the light source of the transmission means of the optical transmission apparatus 11 and the light source of the reception means of the other optical transmission apparatus 12.

The MIMO equalizer according to the second example embodiment compensates for the frequency characteristic difference between the IQs of the transmission means (transmission unit) and the reception means (reception unit) using the filter coefficients of the FIR filters.

### Third Example Embodiment

A system 30 according to a third example embodiment differs from the system 10 according to the first example embodiment in that, in the system 30, the other optical transmission apparatus 12 has chromatic dispersion compensation means. The chromatic dispersion compensation means compensates for the inphase component and the quadrature component of the chromatic dispersion generated by transmitting the optical modulation signal via the optical transmission path.

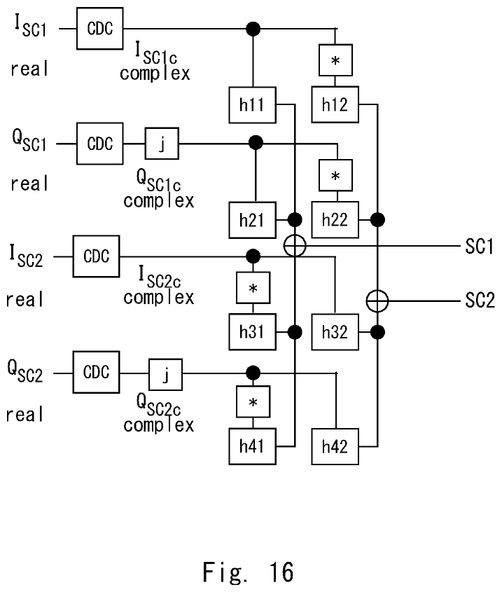

FIG. 16 is a block diagram showing an example of a 4×2 MIMO equalizer according to the third example embodiment.

In FIG. 16, the first subcarrier SC1 is divided into an inphase component I_{SC1} and a quadrature component Q_{SC1}, and the second subcarrier SC2 is divided into an inphase component I_{SC2} and a quadrature component Q_{SC2}. The components after passing through the Chromatic Dispersion Compensation (CDC) device are I_{SC1c}, Q_{SC1c}, I_{SC2c}, and Q_{SC2}.

The 4×2 MIMO equalizer according to the third example embodiment includes frequency error detection means, compensation means, and Chromatic Dispersion Compensation (CDC) device.

As shown in FIG. 16, the Chromatic Dispersion Compensation means compensates for the inphase component I_{SC1} and the quadrature component Q_{SC1} of the chromatic dispersion of the first subcarrier SC1 and the inphase component I_{SC2} and the quadrature component Q_{SC2} of the chromatic dispersion of the second subcarrier SC2 using the Chromatic Dispersion Compensation (CDC) device. The Chromatic dispersion compensation device is arranged, for example, before the 4×2 MIMO equalizer. The Chromatic Dispersion Compensation means may compensate for the chromatic dispersion using, for example, a chromatic dispersion compensation filter.

When a mixed IQ signal of the inphase and quadrature components is compensated by the Chromatic dispersion compensation device, IQ mixing occurs. Therefore, in the third example embodiment, the inphase component (I signal) and the quadrature component (Q signal) are dispersion-compensated independently. Thus, the occurrence of IQ mixing can be reduced.

The relationship between the first subcarrier SC1 and component I_{SC1c} after CDC of the inphase component of the received first subcarrier SC1, the component Q_{SC1c} after CDC of the quadrature component of the received first subcarrier SC1, the component I_{SC2c} after CDC of the inphase component of the received second subcarrier SC2, and the component Q_{SC2c} after CDC of the quadrature component of the received second subcarrier SC2 is shown in Expression 11. Additionally, the relationship between the second subcarrier SC2 and component ISC1c after CDC of the inphase component of the received first subcarrier SC1, the component QSC1c after CDC of the quadrature component of the received first subcarrier SC1, the component ISC2C after CDC of the inphase component of the received second subcarrier SC2, and the component QSC2C after CDC of the quadrature component of the received second subcarrier SC2 is shown in Expression 12.

$$SC 1 = ( {h}_{11} {I}_{SC 1 c} + {jh}_{21} {Q}_{SC 1 c} ) + ( {h}_{31} {I}_{SC 2 c}^{*} + {jh}_{41} {Q}_{SC 2 c}^{*} ) \qquad ( Expression 11 )$$

$$SC 2 = ( {h}_{12} {I}_{SC 1 c}^{*} + {jh}_{22} {Q}_{SC 1 c}^{*} ) + ( {h}_{32} {I}_{SC 2 c} + {jh}_{42} {Q}_{SC 2 c} ) \qquad ( Expression 12 )$$

### Fourth Example Embodiment

A system 40 according to a fourth example embodiment is a system in which the system 20 according to the second example embodiment and the system according to the third example embodiment are simultaneously applied.

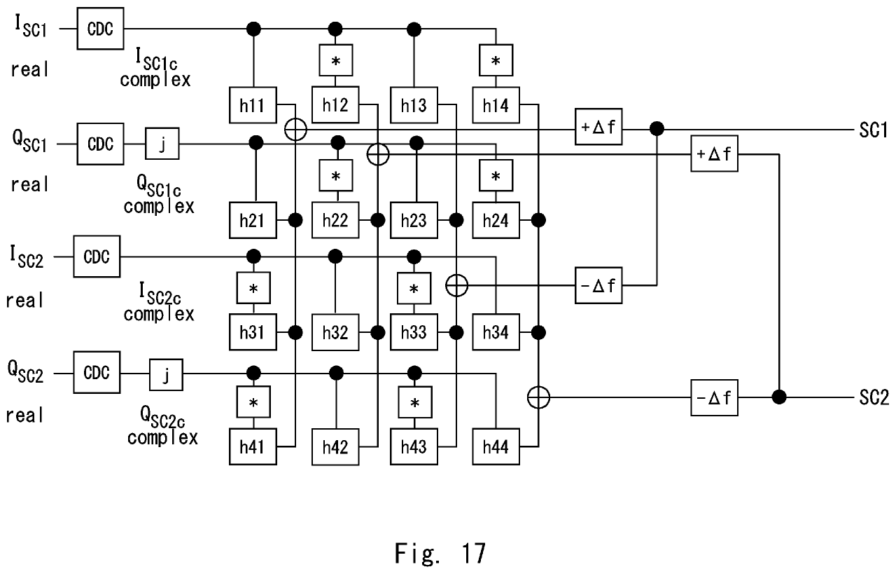

FIG. 17 is a block diagram showing an example of a 4×2 MIMO equalizer according to the fourth example embodiment.

A chromatic dispersion compensation device is arranged before the 4×2 MIMO equalizer according to the fourth example embodiment to compensate for the frequency characteristic difference between the IQ of the transmitter side and that of the receiver side.

The relationship between the first subcarrier SC1 and the inphase component I_{SC1} of the received first subcarrier SC1, the quadrature component Q_{SC1} of the received first subcarrier SC1, the inphase component ISC2 of the received second subcarrier, and the quadrature component Q_{SC2} of the received second subcarrier SC2 is shown in Expression 13. Additionally, the relationship between the second subcarrier SC2 and the inphase component I_{SC1} of the received first subcarrier SC1, the quadrature component Q_{SC1} of the received first subcarrier SC1, the inphase component I_{SC2} of the received second subcarrier, and the quadrature component Q_{SC2} of the received second subcarrier SC2 is shown in Expression 14.

$$SC 1 = ( ( Δ {fh}_{11} - Δ {fh}_{13} ) {I}_{SC 1 c} + j ( Δ {fh}_{21} - Δ {fh}_{23} ) {Q}_{SC 1 c} ) + ( ( Δ {fh}_{31} - Δ {fh}_{33} ) {I}_{SC2 c}^{*} + j ( Δ {fh}_{41} - Δ {fh}_{43} ) {Q}_{SC 2 c}^{*} ) \qquad ( Expression 13 )$$

$$SC 2 = ( ( Δ {fh}_{12} - Δ {fh}_{14} ) {I}_{SC 1 c}^{*} + j ( Δ {fh}_{22} - Δ {fh}_{24} ) {Q}_{SC 1 c}^{*} ) + ( ( Δ {fh}_{32} - Δ {fh}_{34} ) {I}_{SC2 c} + j ( Δ {fh}_{42} - Δ {fh}_{44} ) {Q}_{SC 2 c} ) \qquad ( Expression 14 )$$

### Fifth Example Embodiment

A system 50 according to a fifth example embodiment uses an equalizer to detect and compensate for frequency characteristic differences in a state where a plurality of subcarrier SCs are independent. For example, when an equalizer is provided in reception means of an optical transmission apparatus, the equalizer is provided after the separation of the plurality of subcarrier SCs. As another example, when the equalizer is provided in transmission means of an optical transmission apparatus, the equalizer is provided before the synthesis of the plurality of subcarrier SCs. The synthesis is sometimes referred to as multiplexing.

<When Equalizer is Provided after Separation of Subcarriers>

A case where an equalizer is provided after separation of a plurality of subcarrier SCs will be described.

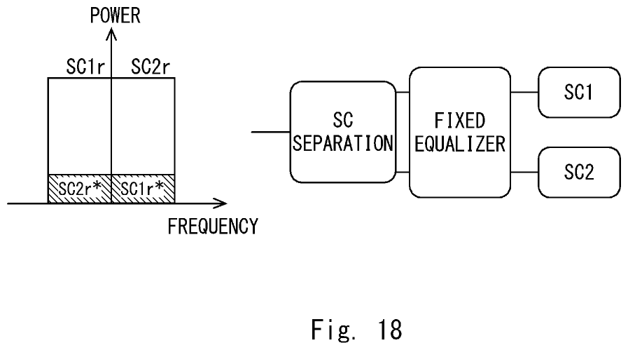

FIG. 18 is a schematic diagram showing an example of a part of reception means of an optical transmission apparatus according to the fifth example embodiment.

FIG. 18 shows the received first subcarrier as SC1r and the received second subcarrier as SC2r.

In the fifth example embodiment, during the reception of the first pilot signal of the first subcarrier SC1r, the second pilot signal of the second subcarrier SC2r is not received, and during the reception of the second pilot signal of the second subcarrier SC2r, the first pilot signal of the first subcarrier SC1r is not received. In FIG. 18, for simplicity, the waveforms during the reception of the first subcarrier SC1r and the waveforms during the reception of the second subcarrier SC2r are superimposed. Both the first data signal of the first subcarrier SC1r and the second data signal of the second subcarrier SC1r are received.

As shown in FIG. 18, the equalizer compensates for the frequency characteristic difference after separating the first subcarrier SC1r and the second subcarrier SC2r. The first subcarrier SC1 includes the first digital signal, and the second subcarrier SC2 includes the second digital signal. IQ mixing is caused by devices and does not necessitate adaptive equalization, such as MIMO equalizers. Therefore, the equalizer according to the fifth example embodiment is a fixed equalizer. In the fixed equalizer, a predetermined filter coefficient is used as the filter coefficient of the equalizer. The filter coefficient of the fixed equalizer is calculated by an external computer based on output data of the ADC (see FIG. 1). The filter coefficient of the fixed equalizer is calculated, for example, from computations performed by an external computer in advance performing processing of the MIMO equalizer according to one of the aforementioned first to fourth example embodiments.

### <When Equalizer is Provided Before Synthesis (Multiplexing) of Subcarriers>

A case where an equalizer is provided before synthesis of a plurality of subcarrier SCs will be described.

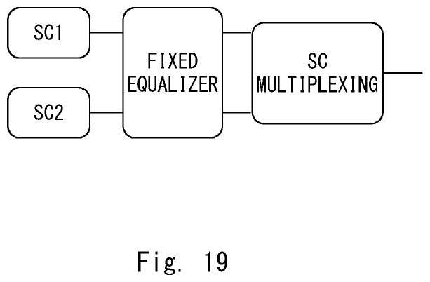

FIG. 19 is a schematic diagram showing an example of a part of transmission means of the optical transmission apparatus according to the fifth example embodiment.

As shown in FIG. 19, on the transmission side of the optical transmission apparatus, in order to compensate for the frequency characteristic difference between the inphase (I) and quadrature (Q) components (between IQ) of the subcarriers (SC), a transmission-side MIMO equalizer can be provided in the transmission means of the optical transmission apparatus. The optical transmission apparatus uses the equalizer to compensate for the frequency characteristic difference in the transmission means.

The frequency characteristic difference is, for example, the frequency characteristic difference of the delay and amplitude between the inphase component and the quadrature component of the first pilot signal. Furthermore, the frequency characteristic difference is, for example, the difference in the frequency characteristics of the delay and amplitude between the inphase component and the quadrature component of the second pilot signal.

Specifically, the optical transmission apparatus, similar to the reception side, includes on the transmitting side transmission-side frequency characteristic difference compensation means. The transmission-side frequency characteristic difference compensation means compensates for a transmission-side frequency characteristic difference between the inphase component and the quadrature component of the first data signal using the first pilot signal and between the inphase component and the quadrature component of the second data signal using the second pilot signal on the transmission side.

The transmission-side frequency characteristic difference compensation means has a transmission-side MIMO equalizer. The transmission-side MIMO equalizer has a plurality of transmission-side Finite Impulse Response (FIR) filters for compensating for the transmission-side frequency characteristic difference. Each of the plurality of transmission-side FIR filters has a transmission-side filter coefficient.

The transmission-side frequency characteristic difference compensation means compensates for the transmission-side frequency characteristic difference by using the transmission-side MIMO equalizer instead of the frequency characteristic difference compensation means of the optical transmission apparatus for receiving the subcarrier SC.

The frequency characteristic difference between the inphase component and the quadrature component (IQ) is mainly caused by a device (component) mounted on the optical transmission apparatus. As a result, the variation period of the frequency characteristic difference is in minutes or hours. Thus, adaptive equalization such as MIMO equalizer is not necessary. Thus, the equalizer according to the fifth example embodiment is an equalizer with fixed filter coefficients (fixed equalizer).

The transmission-side frequency characteristic difference compensation means obtains a predetermined transmission-side filter coefficient in advance using the transmission-side MIMO equalizer. Specifically, the filter coefficient of the fixed equalizer is calculated by an external computer based on output data of the ADC (see FIG. 1). The filter coefficient of the fixed equalizer is calculated, for example, from computations performed by an external computer in advance performing processing of the MIMO equalizer according to the second or fourth example embodiment. After that, the transmission-side frequency characteristic difference compensation means operates the transmission-side MIMO equalizer using the obtained predetermined transmission-side filter coefficient to compensate for the transmission-side frequency characteristic difference.

That is, the transmission-side MIMO equalizer (fixed equalizer) with the predetermined transmission-side filter coefficient compensates for the transmission-side frequency characteristic difference before synthesizing the first digital signal of the first subcarrier SC1 and the second digital signal of the second subcarrier SC2.

### Sixth Example Embodiment

A system 60 according to a sixth example embodiment compensates for the frequency characteristic difference using an equalizer in a state where a plurality of subcarrier SCs are multiplexed (synthesized). For example, when an equalizer is provided in reception means of an optical transmission apparatus, the equalizer is provided before separation of a plurality of subcarrier SCs. For example, when an equalizer is provided in transmission means of an optical transmission apparatus, the equalizer is provided after synthesis of the plurality of subcarrier SCs. The multiplexing is sometimes referred to as synthesis.

### <When Equalizer is Provided Before Separation of Subcarriers>

A case where an equalizer is provided before separation of a plurality of subcarriers SC will be described.

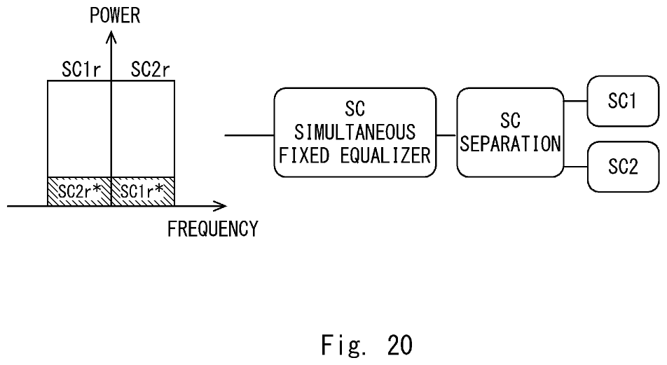

FIG. 20 is a schematic diagram showing an example of a part of reception means of an optical transmission apparatus according to the sixth example embodiment.

FIG. 20 shows a received first subcarrier as SC1r and a received second subcarrier as SC2r.

In the sixth example embodiment, during the reception of the first pilot signal of the first subcarrier SC1r, the second pilot signal of the second subcarrier SC2r is not received, and during the reception of the second pilot signal of the second subcarrier SC2r, the first pilot signal of the first subcarrier SC1r is not received. In FIG. 20, for simplicity, the waveforms during the reception of the first subcarrier SC1r and the waveforms during the reception of the second subcarrier SC2r are superimposed. Both the first data signal of the first subcarrier SC1r and the second data signal of the second subcarrier SC1r are received.

As shown in FIG. 20, an SC simultaneous equalizer compensates for the frequency characteristic difference before separating the first digital signal of the first subcarrier SC1r and the second digital signal of the second subcarrier SC2r. IQ mixing is caused by devices and does not necessitate adaptive equalization, such as MIMO equalizers. Thus, the SC simultaneous equalizer according to the sixth example embodiment is a fixed equalizer. In the fixed equalizer, a predetermined filter coefficient is used as the filter coefficient of the equalizer. The filter coefficient of the fixed equalizer is calculated by an external computer based on output data of the ADC (see FIG. 1). The filter coefficient of the fixed equalizer is calculated, for example, from computations performed by an external computer in advance performing processing of the MIMO equalizer according to one of the aforementioned first to fourth example embodiments. By employing the predetermined filter coefficients as the filter coefficients for the SC simultaneous equalizer, the SC simultaneous equalizer operates as a fixed equalizer to simultaneously compensate for the IQ frequency characteristic difference of the subcarriers. Note that the filter coefficients of the SC simultaneous equalizer (fixed equalizer) can be periodically updated.

<When Equalizer is Provided after Synthesis of a Plurality of Subcarriers>

A case where an equalizer is provided after synthesis of a plurality of subcarriers SC will be described.

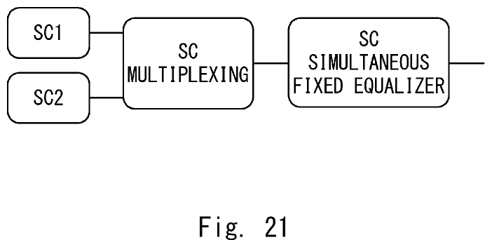

FIG. 21 is a schematic diagram showing an example of a part of transmission means of the optical transmission apparatus according to the sixth example embodiment.

In the sixth example embodiment, during the transmission of the first pilot signal of the first subcarrier SC1, the second pilot signal of the second subcarrier SC2 is not transmitted, and during the transmission of the second pilot signal of the second subcarrier SC2, the first pilot signal of the first subcarrier SC1 is not transmitted. Both the first data signal of the first subcarrier SC1 and the second data signal of the second subcarrier SC1 are received.

As shown in FIG. 21, the transmission-side SC simultaneous equalizer compensates for the transmission-side frequency characteristic difference after synthesizing the first digital signal of the first subcarrier SC1 and the second digital signal of the second subcarrier SC2. IQ mixing is caused by devices and does not necessitate adaptive equalization, such as MIMO equalizers. Thus, the transmission-side SC simultaneous equalizer according to the sixth example embodiment is a fixed equalizer. In the fixed equalizer, a predetermined filter coefficient is used as the filter coefficient of the equalizer. The filter coefficient of the fixed equalizer is calculated by an external computer based on output data of the ADC (see FIG. 1). The filter coefficient of the fixed equalizer is calculated, for example, from computations performed by an external computer in advance performing processing of the MIMO equalizer according to the aforementioned second or fourth example embodiment. By employing the predetermined filter coefficients as the filter coefficients for the SC simultaneous equalizer, the SC simultaneous equalizer operates as a fixed equalizer to simultaneously compensate for the IQ frequency characteristic difference of the subcarriers. Note that the filter coefficients of the SC simultaneous equalizer (fixed equalizer) can be periodically updated.

### Seventh Example Embodiment

An optical transmission apparatus 71 according to a seventh example embodiment is characterized by a transmission pattern of a subcarrier SC.

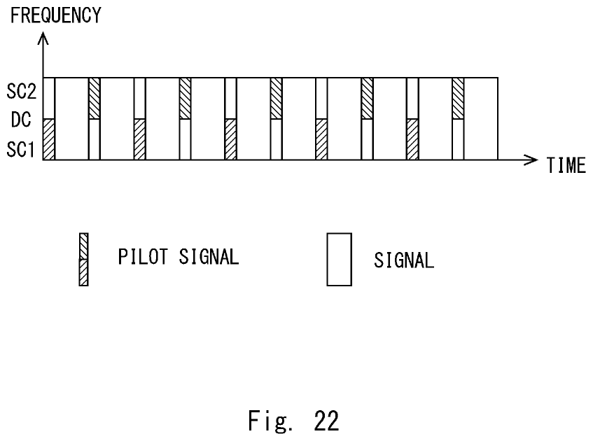

FIG. 22 is a schematic diagram showing an example of a state of transmitting pilot signals according to the seventh example embodiment.

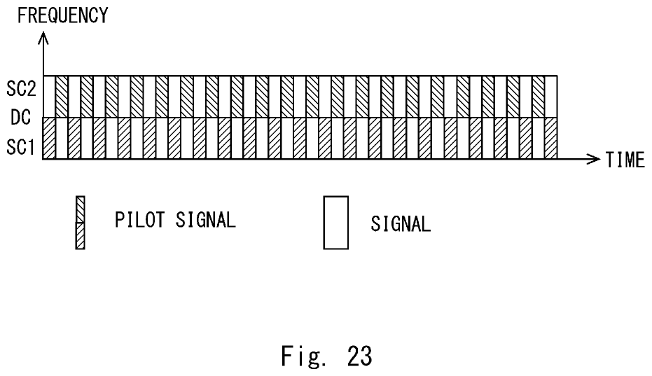

FIG. 23 is a schematic diagram showing an example of a state of transmitting pilot signals according to the seventh example embodiment.

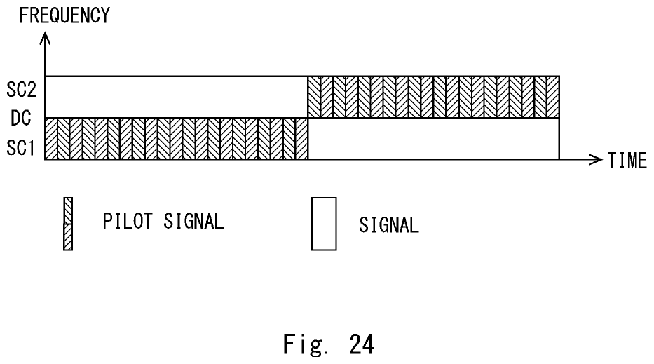

FIG. 24 is a schematic diagram showing an example of a state of transmitting pilot signals according to the seventh example embodiment.

In FIGS. 22 to 24, the horizontal axis represents time, and the vertical axis represents frequency.

As shown in FIG. 22, the optical transmission apparatus 71 transmits data signals and pilot signals in a pattern in which pilot signals are inserted between data signals and other data signals.

Also as shown in FIG. 23, the optical transmission apparatus 71 may transmit pilot signals at all times for the purpose of calibrating a device that induces a frequency characteristic difference between IQs. This transmission pattern is referred to as a first transmission pattern.

As shown in FIG. 24, the optical transmission apparatus 71 may transmit pilot signals at all times. This transmission pattern is referred to as a second transmission pattern. A switching period from the first subcarrier SC1 to the second subcarrier SC2 in the second transmission pattern is longer than that in the first transmission pattern.

Although the present disclosure has been described as a hardware configuration in the above example embodiments, the present disclosure is not limited thereto. The processing of each component can also be implemented by causing a CPU (Central Processing Unit) to execute a computer program.

In the above example embodiments, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Although the present disclosure has been described with reference to example embodiments, the present disclosure is not limited by the above. Various changes in the configurations and details of the present disclosure may be made within the scope of the disclosure that may be understood by those skilled in the art.

The present disclosure is not limited to the above example embodiments, and may be suitably changed to the extent that it does not deviate from the purpose.

The whole or part of the example embodiments disclosed above can be described as, but not limited to, the following supplementary notes.

### Supplementary Note 1

An optical transmission apparatus comprising:
pilot addition means for generating a first digital signal by adding a first pilot signal to a first data signal and generating a second digital signal by adding a second pilot signal to a second data signal; and
optical modulation means for generating an optical modulation signal by optically modulating the first digital signal with a first subcarrier included in a negative frequency band to a center frequency of a used frequency band, optically modulating the second digital signal with a second subcarrier included in a positive frequency band to the center frequency of the used frequency band, and transmitting the optical modulation signal, wherein
the pilot addition means does not transmit the second pilot signal during transmission of the first pilot signal, and
the pilot addition means does not transmit the first pilot signal during transmission of the second pilot signal.

### Supplementary Note 2

The optical transmission apparatus according to supplementary note 1, further comprising data signal generation means for generating a data signal by performing encoding processing on information to be transmitted, wherein the data signal includes the first data signal and the second data signal.

### Supplementary Note 3

The optical transmission apparatus according to supplementary note 1 or 2, further comprising:
first IQ conversion means for converting the first digital signal into an inphase component and a quadrature component; and
second IQ conversion means for converting the second digital signal into an inphase component and a quadrature component, wherein the optical modulation means generates the optical modulation signal by optically modulating each of the inphase component and the quadrature component of the first digital signal with the first subcarrier, and optically modulating each of the inphase component and the quadrature component of the second digital signal with the second subcarrier.

### Supplementary Note 4

The optical transmission apparatus according to any one of supplementary notes 1 to 3, wherein the optical modulation means includes optical signal synthesis means for synthesizing the optically-modulated inphase component and quadrature component of the optical modulation signal.

### Supplementary Note 5

The optical transmission apparatus according to any one of supplementary notes 1 to 4, further comprising subcarrier generation means for generating a plurality of subcarriers, wherein the first subcarrier and the second subcarrier are selected from among the plurality of subcarriers.

### Supplementary Note 6

The optical transmission apparatus according to any one of supplementary notes 1 to 5, wherein the optical modulation means optically modulates each of the first digital signal and the second digital signal by a phase modulation method or a quadrature modulation method.

### Supplementary Note 7

The optical transmission apparatus according to any one of supplementary notes 1 to 6, wherein the optical modulation means performs the optical modulation with a Mach-Zender (MZ) modulator.

### Supplementary Note 8

The optical transmission apparatus according to any one of supplementary notes 1 to 7, further comprising pilot signal generation means for generating the first pilot signal and the second pilot signal.

### Supplementary Note 9

The optical transmission apparatus according to any one of supplementary notes 1 to 8, wherein the pilot addition means alternately transmits the first pilot signal and the second pilot signal.

### Supplementary Note 10

The optical transmission apparatus according to any one of supplementary notes 1 to 9, wherein the pilot addition means determines a duration of a transmission time for transmitting the first data signal and a duration of a transmission time for transmitting the first pilot signal based on a data volume of the first data signal.

### Supplementary Note 11

An optical transmission apparatus comprising:
pilot addition means for generating a first digital signal by adding a first pilot signal to a first data signal, generating a second digital signal by adding a second pilot signal to a second data signal, generating a third digital signal by adding a third pilot signal to a third data signal, and generating a fourth digital signal by adding a fourth pilot signal to a fourth data signal;
optical modulation means for generating an X optical modulation signal by optically modulating the first digital signal in X-polarization using a first subcarrier included in a negative frequency band to a center frequency of a used frequency band and optically modulating the second digital signal in the X-polarization using a second subcarrier included in a positive frequency band to the center frequency of the used frequency band, and generating a Y optical modulation signal by optically modulating the third digital signal in Y-polarization using the first subcarrier and optically modulating the fourth digital signal in the Y-polarization using the second subcarrier, and transmitting the X optical modulation signal and the Y optical modulation signal; and
polarization synthesis means for synthesizing the X optical modulation signal and the Y optical modulation signal, wherein
the pilot addition means does not transmit the second pilot signal and the fourth pilot signal during transmission of the first pilot signal and the third pilot signal, and
the pilot addition means does not transmit the first pilot signal and the third pilot signal during transmission of the second pilot signal and the fourth pilot signal.

### Supplementary Note 12

An optical transmission apparatus comprising:
pilot addition means for generating a first digital signal by adding a first pilot signal to a first data signal, generating a second digital signal by adding a second pilot signal to a second data signal, generating a third digital signal by adding a third pilot signal to a third data signal, and generating a fourth digital signal by adding a fourth pilot signal to a fourth data signal; and
optical modulation means for generating an optical modulation signal by optically modulating the first digital signal with a first subcarrier included in a negative frequency band to a center frequency of a used frequency band, optically modulating the second digital signal with a second subcarrier included in a negative frequency band to the center frequency of the used frequency band, optically modulating the third digital signal with a third subcarrier included in a positive frequency band to the center frequency of the used frequency band, and optically modulating the fourth digital signal with a fourth subcarrier included in a positive frequency band to the center frequency of the used frequency band, and transmitting the optical modulation signal, wherein
the pilot addition means does not transmit the third pilot signal and the fourth pilot signal during transmission of the first pilot signal and the second pilot signal, and
the pilot addition means does not transmit the first pilot signal and the second pilot signal during transmission of the third pilot signal and the fourth pilot signal.

### Supplementary Note 13

A system comprising:
an optical transmission apparatus; and
another one of the optical transmission apparatus configured to receive an optical modulation signal from the optical transmission apparatus through an optical transmission path, wherein
the optical transmission apparatus comprises:
   pilot addition means for generating a first digital signal by adding a first pilot signal to a first data signal and generating a second digital signal by adding a second pilot signal to a second data signal; and
   optical modulation means for generating the optical modulation signal by optically modulating the first digital signal with a first subcarrier included in a negative frequency band to a center frequency of a used frequency band, optically modulating the second digital signal with a second subcarrier included in a positive frequency band to the center frequency of the used frequency band, and transmitting the optical modulation signal,
the pilot addition means does not transmit the second pilot signal during transmission of the first pilot signal, and
the pilot addition means does not transmit the first pilot signal during transmission of the second pilot signal,
the other optical transmission apparatus comprises:
optical signal reception means for receiving the first digital signal obtained by coherent detection of the optical modulation signal and the second digital signal obtained by the coherent detection of the optical modulation signal;
position detection means for detecting a position of the first pilot signal within the first digital signal and a position of the second pilot signal within the second digital signal; and
frequency characteristic difference compensation means for compensating for a frequency characteristic difference between an inphase component and a quadrature component of the first data signal using the first pilot signal and compensating for a frequency characteristic difference between an inphase component and a quadrature component of the second data signal using the second pilot signal.

### Supplementary Note 14

The system according to supplementary note 13, wherein the other optical transmission apparatuses comprises an optical source error compensation means for compensating for a frequency error between a light source for modulation included in the optical transmission apparatus for the optical modulation and a light source for detection used for the coherent detection.

### Supplementary Note 15

The system according to supplementary note 13 or 14, wherein the optical signal reception means comprises chromatic dispersion compensation means for compensating for the inphase component and quadrature component of chromatic dispersion that occur from the transmission of the optical modulation signal through the optical transmission path.

### Supplementary Note 16

The system according to supplementary note 15, wherein the chromatic dispersion compensation means uses a Chromatic Dispersion Compensation (CDC) device to compensate for the inphase component and quadrature component of the chromatic dispersion.

### Supplementary Note 17

The system according to supplementary note 13, wherein
the frequency characteristic difference compensation means includes a MIMO (Multi Input Multi Output) equalizer,
the MIMO equalizer includes a plurality of Finite Impulse Response (FIR) filters for compensating for the frequency characteristic difference, and
each of the plurality of FIR filters includes a filter coefficient, and
the frequency characteristic difference compensation means uses the MIMO equalizer to compensate for the frequency characteristic difference.

### Supplementary Note 18

The system according to supplementary note 17, wherein
the frequency characteristic difference compensation means obtains the predetermined filter coefficient using the MIMO equalizer, and
the frequency characteristic difference compensation means operates the MIMO equalizer using the predetermined filter coefficient and compensates for the frequency characteristic difference.

### Supplementary Note 19

The system according to supplementary note 17 or 18, wherein the MIMO equalizer compensates for the frequency characteristic difference after separating the first digital signal and the second digital signal.

### Supplementary Note 20

The system according to supplementary note 17 or 18, wherein the MIMO equalizer compensates for the frequency characteristic difference before separating the first digital signal and the second digital signal.

### Supplementary Note 21

The system according to supplementary note 13, wherein
the optical transmission apparatus comprises transmission-side frequency characteristic difference compensation means for compensating a transmission-side frequency characteristic difference between the inphase component and the quadrature component of the first data signal using the first pilot signal and compensating a transmission-side frequency characteristic difference between the inphase component and the quadrature component of the second data signal using the second pilot signal on the transmission side,
the frequency characteristic difference compensation means includes a transmission-side MIMO (Multi Input Multi Output) equalizer,
the transmission-side MIMO equalizer includes a plurality of transmission-side Finite Impulse Response (FIR) filters for compensating for the transmission-side frequency characteristic difference,
each of the plurality of transmission-side FIR filters includes a transmission-side filter coefficient, and
the transmission-side frequency characteristic difference compensation means uses the transmission-side MIMO equalizer instead of the frequency characteristic difference compensation means of another one of the optical transmission apparatus to compensate for the transmission-side frequency characteristic difference.

### Supplementary Note 22

The system according to supplementary note 21, wherein
the transmission-side frequency characteristic difference compensation means obtains the predetermined transmission-side filter coefficient using the transmission-side MIMO equalizer, and
the transmission-side frequency characteristic difference compensation means operates the transmission-side MIMO equalizer using the predetermined transmission-side filter coefficient and compensates for the transmission-side frequency characteristic difference.

### Supplementary Note 23

The system according to supplementary note 23, wherein the transmission-side MIMO equalizer compensates for the transmission-side frequency characteristic difference before synthesizing the first digital signal with the second digital signal.

### Supplementary Note 24

The system according to claim 21 or 22, wherein the transmission-side MIMO equalizer compensates for the transmission-side frequency characteristic difference after synthesizing the first digital signal and the second digital signal.

### Supplementary Note 25

A method comprising:
generating a first digital signal by adding a first pilot signal to a first data signal and generating a second digital signal by adding a second pilot signal to a second data signal;
generating an optical modulation signal by optically modulating the first digital signal with a first subcarrier included in a negative frequency band to a center frequency of a used frequency band, optically modulating the second digital signal with a second subcarrier included in a positive frequency band to the center frequency of the used frequency band, and transmitting the optical modulation signal;
not transmitting the second pilot signal during transmission of the first pilot signal; and
transmitting the first pilot signal during transmission of the second pilot signal.

### Supplementary Note 26

A non-transitory computer readable medium storing a program for causing a computer to execute:
generating a first digital signal by adding a first pilot signal to a first data signal and generating a second digital signal by adding a second pilot signal to a second data signal;
generating an optical modulation signal by optically modulating the first digital signal with a first subcarrier included in a negative frequency band to a center frequency of a used frequency band, optically modulating the second digital signal with a second subcarrier included in a positive frequency band to the center frequency of the used frequency band, and transmitting the optical modulation signal;
not transmitting the second pilot signal during transmission of the first pilot signal; and
transmitting the first pilot signal during transmission of the second pilot signal.

### REFERENCE SIGNS LIST

10, 20, 30, 40, 50, 60: SYSTEM
11, 71: OPTICAL TRANSMISSION APPARATUS
111: PILOT ADDITION MEANS
112: OPTICAL MODULATION MEANS
113: POLARIZATION SYNTHESIS MEANS
12: ANOTHER OPTICAL TRANSMISSION APPARATUS
126: OPTICAL SIGNAL RECEPTION MEANS
127: POSITION DETECTION MEANS
128: FREQUENCY CHARACTERISTIC DIFFERENCE COMPENSATION MEANS
SC: SUBCARRIER
SC1: FIRST SUBCARRIER
SC2: SECOND SUBCARRIER
SC3: THIRD SUBCARRIER
SC4: FOURTH SUBCARRIER

What is claimed is:

1. An optical transmission apparatus comprising:
at least one memory storing instructions, and
at least one processor configured to execute the instructions to;
generate a first digital signal by adding a first pilot signal to a first data signal and generate a second digital signal by adding a second pilot signal to a second data signal; and
generate an optical modulation signal by optically modulating the first digital signal with a first subcarrier included in a negative frequency band to a center frequency of a used frequency band, optically modulate the second digital signal with a second subcarrier included in a positive frequency band to the center frequency of the used frequency band, and transmit the optical modulation signal, wherein
the at least one processor configured to execute the instructions not to transmit the second pilot signal during transmission of the first pilot signal, and
not to transmit the first pilot signal during transmission of the second pilot signal.

2. The optical transmission apparatus according to claim 1, the at least one processor configured to further execute the instructions to generate a data signal by performing encoding processing on information to be transmitted, wherein the data signal includes the first data signal and the second data signal.

3. The optical transmission apparatus according to claim 1,
the at least one processor configured to further execute the instructions to;
convert the first digital signal into an inphase component and a quadrature component; and
convert the second digital signal into an inphase component and a quadrature component, wherein
the at least one processor configured to further execute the instructions to generate the optical modulation signal by optically modulating each of the inphase component and the quadrature component of the first digital signal with the first subcarrier, and optically modulating each of the inphase component and the quadrature component of the second digital signal with the second subcarrier.

4. The optical transmission apparatus according to claim 1, wherein the at least one processor configured to further execute the instructions to synthesis the optically-modulated inphase component and quadrature component of the optical modulation signal.

5. The optical transmission apparatus according to claim 1, the at least one processor configured to further execute the instructions to generate a plurality of subcarriers, wherein the first subcarrier and the second subcarrier are selected from among the plurality of subcarriers.

6. The optical transmission apparatus according to claim 1, wherein the optical modulation means optically modulates each of the first digital signal and the second digital signal by a phase modulation method or a quadrature modulation method.

7. The optical transmission apparatus according to claim 1, wherein the at least one processor configured to execute the instructions to perform the optical modulation with a Mach-Zender (MZ) modulator.

8. The optical transmission apparatus according to claim 1, the at least one processor configured to further execute the instructions to generate the first pilot signal and the second pilot signal.

9. The optical transmission apparatus according to claim 1, wherein the at least one processor configured to execute the instructions to alternately transmit the first pilot signal and the second pilot signal.

10. The optical transmission apparatus according to claim 1, wherein the at least one processor configured to execute the instructions to determine a duration of a transmission time for transmitting the first data signal and a duration of a transmission time for transmitting the first pilot signal based on a data volume of the first data signal.

11. An optical transmission apparatus comprising:
at least one memory storing instructions, and
at least one processor configured to execute the instructions to;
generate a first digital signal by adding a first pilot signal to a first data signal, generate a second digital signal by adding a second pilot signal to a second data signal, generate a third digital signal by adding a third pilot signal to a third data signal, and generate a fourth digital signal by adding a fourth pilot signal to a fourth data signal;
generate an X optical modulation signal by optically modulating the first digital signal in X-polarization using a first subcarrier included in a negative frequency band to a center frequency of a used frequency band and optically modulate the second digital signal in the X-polarization using a second subcarrier included in a positive frequency band to the center frequency of the used frequency band, and generate a Y optical modulation signal by optically modulating the third digital signal in Y-polarization using the first subcarrier and optically modulate the fourth digital signal in the Y-polarization using the second subcarrier, and transmit the X optical modulation signal and the Y optical modulation signal; and
synthesize the X optical modulation signal and the Y optical modulation signal, wherein
the at least one processor configured to execute the instructions not to transmit the second pilot signal and the fourth pilot signal during transmission of the first pilot signal and the third pilot signal, and
not to transmit the first pilot signal and the third pilot signal during transmission of the second pilot signal and the fourth pilot signal.

12. (canceled)

13. A system comprising:
an optical transmission apparatus; and
another one of the optical transmission apparatus configured to receive an optical modulation signal from the optical transmission apparatus through an optical transmission path, wherein
the optical transmission apparatus comprises:
at least one memory storing instructions, and
at least one processor configured to execute the instructions to;
generate a first digital signal by adding a first pilot signal to a first data signal and generate a second digital signal by adding a second pilot signal to a second data signal; and
generate the optical modulation signal by optically modulating the first digital signal with a first subcarrier included in a negative frequency band to a center frequency of a used frequency band, optically modulate the second digital signal with a second subcarrier included in a positive frequency band to the center frequency of the used frequency band, and transmit the optical modulation signal,
the pilot addition means does not transmit the second pilot signal during transmission of the first pilot signal, and
the at least one processor configured to execute the instructions not to transmit the first pilot signal during transmission of the second pilot signal,
the other optical transmission apparatus comprises:
at least one other memory storing instructions, and
at least one other processor configured to execute the instructions to;
receive the first digital signal obtained by coherent detection of the optical modulation signal and the second digital signal obtained by the coherent detection of the optical modulation signal;
detect a position of the first pilot signal within the first digital signal and a position of the second pilot signal within the second digital signal; and
compensate for a frequency characteristic difference between an inphase component and a quadrature component of the first data signal using the first pilot signal and compensate for a frequency characteristic difference between an inphase component and a quadrature component of the second data signal using the second pilot signal.

14. The system according to claim 13, wherein the other optical transmission apparatuses compensate for a frequency error between a light source for modulation included in the optical transmission apparatus for the optical modulation and a light source for detection used for the coherent detection.

15. The system according to claim 13, wherein the at least one other processor configured to execute the instructions to compensate for the inphase component and quadrature component of chromatic dispersion that occur from the transmission of the optical modulation signal through the optical transmission path.

16. The system according to claim 15, wherein the at least one other processor configured to execute the instructions to use a Chromatic Dispersion Compensation (CDC) device to compensate for the inphase component and quadrature component of the chromatic dispersion.

17. The system according to claim 13, wherein
the at least one other processor configured to execute the instructions to include a MIMO (Multi Input Multi Output) equalizer,
the MIMO equalizer includes a plurality of Finite Impulse Response (FIR) filters for compensating for the frequency characteristic difference,
each of the plurality of FIR filters includes a filter coefficient, and
the at least one other processor configured to execute the instructions to use the MIMO equalizer to compensate for the frequency characteristic difference.

18. The system according to claim 17, wherein
the at least one other processor configured to execute the instructions to obtain the predetermined filter coefficient using the MIMO equalizer, and
the at least one other processor configured to execute the instructions to operate the MIMO equalizer using the predetermined filter coefficient and compensate for the frequency characteristic difference.

19. The system according to claim 17, wherein the MIMO equalizer compensates for the frequency characteristic difference after separating the first digital signal and the second digital signal.

20. The system according to claim 17, wherein the MIMO equalizer compensates for the frequency characteristic difference before separating the first digital signal and the second digital signal.

21. The system according to claim 13, wherein
the optical transmission apparatus comprises:
at least one memory storing instructions, and
at least one processor configured to execute the instructions to;
compensate a transmission-side frequency characteristic difference between the inphase component and the quadrature component of the first data signal using the first pilot signal and
compensate a transmission-side frequency characteristic difference between the inphase component and the quadrature component of the second data signal using the second pilot signal on the transmission side,
the optical transmission apparatus comprises a transmission-side MIMO (Multi Input Multi Output) equalizer,
the transmission-side MIMO equalizer includes a plurality of transmission-side Finite Impulse Response (FIR) filters for compensating for the transmission-side frequency characteristic difference,
each of the plurality of transmission-side FIR filters includes a transmission-side filter coefficient, and
the at least one processor configured to execute the instructions to compensate for the transmission-side frequency characteristic difference.

22-26. (canceled)
